(19) United States
(12) Patent Application Publication
(10) Pub. No.: US 2025/0274861 A1
(43) Pub. Date: Aug. 28, 2025

(54) SENSING IN A POWER-SAVING MODE IN A WIRELESS COMMUNICATION SYSTEM

(71) Applicant: Huawei Technologies Co., Ltd., Shenzhen (CN)

(72) Inventors: Liqing Zhang, Ottawa (CA); Hao Tang, Ottawa (CA); Jianglei Ma, Ottawa (CA); Lei Dong, Shanghai (CN)

(21) Appl. No.: 19/184,449

(22) Filed: Apr. 21, 2025

Related U.S. Application Data
(63) Continuation of application No. PCT/CN2022/139452, filed on Dec. 16, 2022.

(51) Int. Cl. H04W 52/02; G01S 7/00; G01S 13/86

(52) U.S. Cl. CPC H04W 52/0225; G01S 7/006; G01S 13/86

(57) ABSTRACT

In some wireless communication scenarios, a user equipment (UE) may perform sensing and feedback measurements or results, which a transmit-and-receive point (TRP) may then use to determine information about objects and/or conditions in the vicinity of the TRP. However, the UE might be in a power-saving mode when the TRP requires the UE to perform the sensing. In some embodiments, the UE can be triggered, in the power-saving mode, to perform sensing. The sensing may also be performed in the power-saving mode.

### CROSS-REFERENCE TO RELATED APPLICATION

This application is a continuation of PCT Application No. PCT/CN2022/139452, entitled “SENSING IN A POWER-SAVING MODE IN A WIRELESS COMMUNICATION SYSTEM,” filed on Dec. 16, 2022, which application is hereby incorporated herein by reference in its entirety.

### TECHNICAL FIELD

The present application relates to triggering sensing and performing sensing in a wireless communication system.

### BACKGROUND

In some wireless communication systems, electronic devices, such as user equipments (UEs), wirelessly communicate with a network via one or more transmit-and-receive points (TRPs). A TRP may be a terrestrial TRP (T-TRP) or non-terrestrial TRP (NT-TRP). An example of a T-TRP is a stationary base station or Node B. An example of a NT-TRP is a TRP that can move through space to relocate, e.g. a TRP mounted on a drone, plane, and/or satellite, etc.

A wireless communication from a UE to a TRP is referred to as an uplink communication. A wireless communication from a TRP to a UE is referred to as a downlink communication. Resources are required to perform uplink and downlink communications. For example, a UE may wirelessly transmit information to a TRP in an uplink communication over a particular frequency (or range of frequencies) for a particular duration of time. The frequency and time duration are examples of resources, typically referred to as time-frequency resources. Other examples of resources may include resources in the spatial domain (e.g. the beam that is used), resources in the power domain (e.g. transmission power), etc.

The TRP may sometimes need to determine information about one or more objects and/or conditions present in the vicinity of the TRP. As an example, the TRP might need to track the position and moving direction of a target object. The TRP itself might not be able to directly determine the information.

### SUMMARY

The TRP may wirelessly communicate with one or more UEs. The UEs may perform sensing and feedback measurements or results based on the sensing, which the TRP may then use to determine the required information about the object and/or condition being sensed. As an example, UEs may be located in the vicinity of a target object. The TRP and/or one or more of the UEs may each transmit a sensing signal. The sensing signal may be an electromagnetic wave such as, for example, a radio wave (e.g. in a RADAR system) or a light wave (e.g. in a LiDAR system). In some embodiments, the sensing signal may be a reference signal. The sensing signal may reflect off of the target object and then be received by the UEs. Feedback based on the received sensing signal may then be transmitted by each UE to the TRP in an uplink transmission. One example of feedback that may be transmitted by the UE to the TRP is a set of bits representing a measurement associated with the received sensing signal, e.g. the time at which the wave was received, and/or a detected energy or amplitude of the received reflected wave, and/or an angle of arrival of the received reflected wave. Another example of feedback that may be transmitted by the UE to the TRP is a set of bits representing a value derived by the UE using the received sensing signal, e.g. a location and/or speed and/or direction of movement of the target object. In some embodiments, the feedback from the UE can be sent to the TRP via another UE as a relay over sidelink transmission.

In some scenarios, a UE performing sensing might only need to perform the sensing when requested by the TRP. The TRP may request that a UE perform sensing on an on-demand basis. Therefore, the UE might not know when the TRP is going to request that the UE perform sensing. The UE might be in a power-saving mode when the TRP requires the UE to perform the sensing. For example, the UE and network may operate according to a radio resource control (RRC) protocol, and the UE may be in an RRC Idle state or RRC Inactive state when the TRP wants to instruct the UE to perform sensing. The UE might be deployed by the network for the primary purpose of sensing, and therefore the UE might operate in a power-saving mode all or most of the time. For example, the UE might be a low-cost low-power UE dedicated to sensing and feeding back sensing results. Even if the UE is not a low-cost low-power UE dedicated only to sensing, the UE might still operate in a power-saving mode much of the time to preserve battery life.

If the UE is in a power-saving mode, such as an RRC Idle state or RRC Inactive state, and the TRP wants to instruct the UE perform sensing, the TRP may first have to page the UE to cause the UE to perform a network access procedure, e.g. to cause the UE to perform initial access using a radio access channel (RACH) protocol. Then, once a connection is established (e.g. the UE is in an RRC Connected state), the TRP can instruct the UE to perform the sensing. However, the latency associated with the UE performing the network access procedure may be unacceptable. The TRP may require the sensed feedback from the UE promptly, i.e. there may only be a small window of time between when the TRP determines that the UE is to perform sensing and when the UE must start sensing. There might not be time to transition out of the power-saving mode. Moreover, it may be desired to perform the sensing in the power-saving mode without transitioning out of the power-saving mode, e.g. because the UE is only performing a burst of sensing and feeding back the results, not establishing a communication session with the network that would require transitioning out of the power-saving mode.

Therefore, embodiments are disclosed in which the UE can be triggered to perform sensing and perform the sensing in the power-saving mode. For example, the trigger may be included in a downlink message received by the UE in the power-saving mode. In some embodiments, the downlink message having the trigger to activate sensing may be associated with paging. For example, the downlink message may be a paging message that is supplemented with an indication used for triggering the UE to perform the sensing. As another example, the downlink control information (DCI) scheduling the downlink message may be a DCI that is scrambled (e.g., whose CRC is scrambled, which is applied to the following descriptions in this application) using a paging radio network temporary identifier (P-RNTI).

In one embodiment there is proved a method performed by an apparatus, such as a UE, in a power-saving mode. The method may include receiving, in the power-saving mode, a downlink message including an indication used for triggering the apparatus to perform sensing. In response to receiving the indication, the apparatus may perform in the power-saving mode at least one of: transmitting a sensing signal or receiving the sensing signal. In another embodiment, there is provided a corresponding method performed by a device, e.g. a by a network device, such as a TRP. The method may include transmitting a downlink message, the downlink message including an indication used for triggering the apparatus in the power-saving mode to perform sensing. The method may further include subsequently receiving, from the apparatus in the power-saving mode, feedback obtained by the apparatus from the sensing.

In some embodiments, the downlink message is associated with paging. For example, in some embodiments, the downlink message comprises a paging message supplemented with the indication used for triggering the apparatus to perform sensing. As another example, in some embodiments receiving the downlink message at the apparatus may include the apparatus: receiving DCI that is scrambled by an ID also used for paging (e.g. a P-RNTI); obtaining from the DCI a time-frequency location for the downlink message; and receiving the downlink message at the time-frequency location. In some embodiments, parameters related to the sensing are configured for the apparatus (e.g. using higher-layer signaling such as RRC signaling) before the apparatus enters the power-saving mode or as part of the transition of the apparatus into the power-saving mode. In some embodiments, parameters related to the sensing are configured in the downlink message.

A technical benefit of some embodiments includes the ability for a TRP to promptly trigger one or more UEs in a power-saving mode to perform sensing. Moreover, depending upon the implementation, the method for triggering a UE in the power-saving mode to perform the sensing may be incorporated into existing methods for paging, e.g. by supplementing a paging message with a sensing trigger and/or by using DCI scrambled by a P-RNTI to schedule the downlink message triggering sensing. In some embodiments, the message triggering the sensing may also dynamically configure parameters for performing the sensing and/or dynamically indicate a general location associated with the target object so that the UEs know the general direction for beam steering for transmitting and/or receiving the sensing signal.

Corresponding apparatuses and devices for performing the methods herein are also disclosed.

### BRIEF DESCRIPTION OF THE DRAWINGS

Embodiments will be described, by way of example only, with reference to the accompanying figures wherein:

FIG. 1 is a simplified schematic illustration of a communication system, according to one example;

FIG. 2 illustrates another example of a communication system;

FIG. 3 illustrates an example of an electronic device (ED), a terrestrial transmit and receive point (T-TRP), and a non-terrestrial transmit and receive point (NT-TRP);

FIG. 4 illustrates example units or modules in a device;

FIG. 5 illustrates user equipments (UEs) communicating with a TRP, according to one embodiment;

FIG. 6 illustrates UEs performing sensing of a target object, according to one embodiment;

FIG. 7 illustrates power consumption for a UE when operating in a power-saving mode, according to one embodiment;

FIG. 8 illustrates a method performed by a TRP and a UE, according to one embodiment;

FIG. 9 illustrates one example of a downlink message;

FIGS. 10 to 14 illustrate example ways in which the downlink message may be transmitted;

FIG. 15 illustrates an example of an enhanced paging message;

FIG. 16 is an example of DCI indicating whether the enhanced paging message only triggers sensing, only pages for communication, or both;

FIGS. 17 and 18 illustrate UEs performing sensing, according to some embodiments;

FIG. 19 illustrates an example in which multiple instances of sensing are performed; and

FIG. 20 illustrates a variation of FIG. 6 in which a TRP is triggered to perform sensing.

### DETAILED DESCRIPTION

For illustrative purposes, specific example embodiments will now be explained in greater detail below in conjunction with the figures.

### Example Communication Systems and Devices

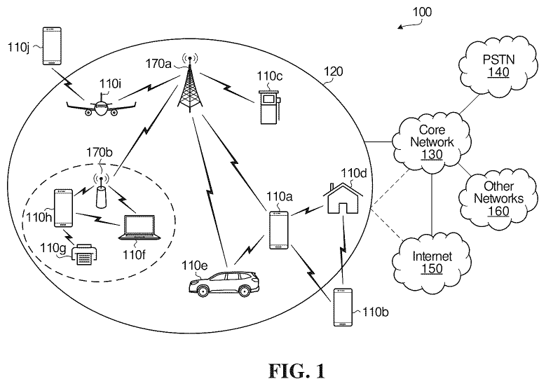

Referring to FIG. 1, as an illustrative example without limitation, a simplified schematic illustration of a communication system 100 is provided. The communication system 100 comprises a radio access network (RAN) 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

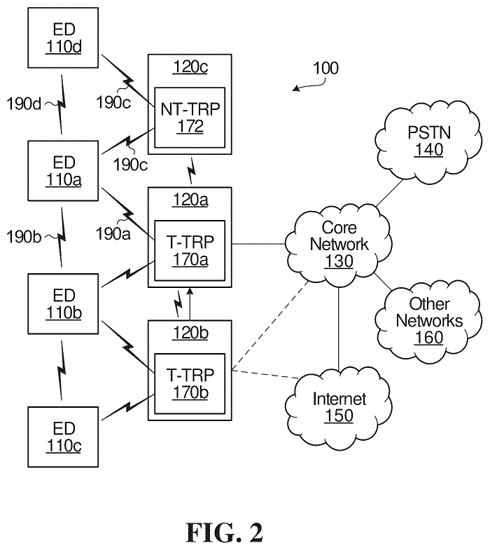

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c (which may also be a RAN or part of a RAN), a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the Eds 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of Eds and one or multiple NT-TRPs for multicast transmission.

The RANs 120a and 120b are in communication with the core network 130 to provide the Eds 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or Eds 110a 110b, and 110c or both, and (ii) other networks (such as the PSTN 140, the internet 150, and the other networks 160). In addition, some or all of the Eds 110a 110b, and 110c may include functionality for communicating with different wireless networks over different wireless links using different wireless technologies and/or protocols. Instead of wireless communication (or in addition thereto), the Eds 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). Eds 110a 110b, and 110c may be multimode devices capable of operation according to multiple radio access technologies, and incorporate multiple transceivers necessary to support such.

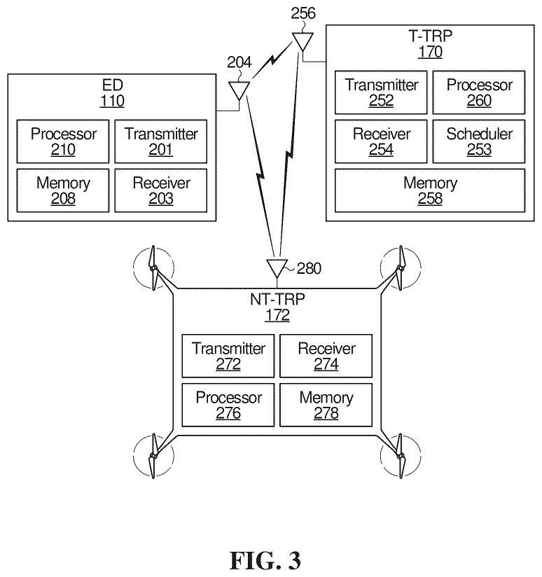

FIG. 3 illustrates another example of an ED 110, a base station 170 (e.g. 170a, and/or 170b), which will be referred to as a T-TRP 170, and a NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation Eds 110 may be referred to using other terms. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transmitter (or transceiver) is configured to modulate data or other content for transmission by the at least one antenna 204 or network interface controller (NIC). The receiver (or transceiver) is configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forgoing devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations which may be described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170. The scheduler 253 may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone, it is only as an example. The NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

Note that “TRP,” as used herein, may refer to a T-TRP or a NT-TRP.

The T-TRP 170, the NT-TRP 172, and/or the ED 110 may include other components, but these have been omitted for the sake of clarity.

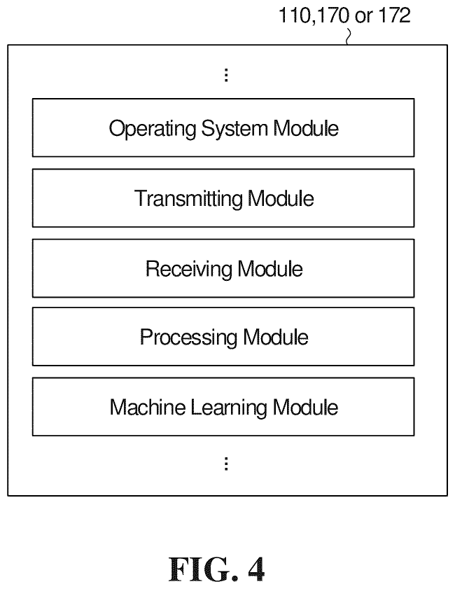

One or more steps of the embodiment methods provided herein may be performed by corresponding units or modules, e.g. according to FIG. 4. FIG. 4 illustrates example units or modules in a device, such as in ED 110, in T-TRP 170, or in NT-TRP 172. For example, operations may be controlled by an operating system module. As another example, a signal may be transmitted by a transmitting unit or a transmitting module. A signal may be received by a receiving unit or a receiving module. A signal may be processed by a processing unit or a processing module. Some operations/steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the Eds 110, T-TRP 170, and NT-TRP 172 are known to those of skill in the art. As such, these details are omitted here.

Control information is discussed herein. Control information may sometimes instead be referred to as control signaling, or signaling. In some cases, control information may be dynamically communicated, e.g. in the physical layer in a control channel, such as in a physical uplink control channel (PUCCH) or physical downlink control channel (PDCCH). An example of control information that is dynamically indicated is information sent in physical layer control signaling, e.g. uplink control information (UCI) sent in a PUCCH or downlink control information (DCI) sent in a PDCCH. A dynamic indication may be an indication in lower layer, e.g. physical layer/layer 1 signaling, rather than in a higher-layer (e.g. rather than in RRC signaling or in a MAC CE). A semi-static indication may be an indication in semi-static signaling. Semi-static signaling, as used herein, may refer to signaling that is not dynamic, e.g. higher-layer signaling (such as RRC signaling), and/or a MAC CE. Dynamic signaling, as used herein, may refer to signaling that is dynamic, e.g. physical layer control signaling sent in the physical layer, such as DCI sent in a PDCCH or UCI sent in a PUCCH.

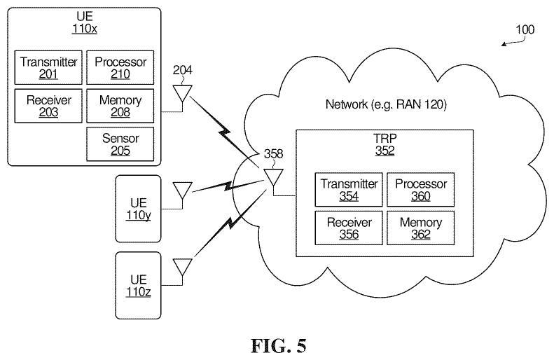

FIG. 5 illustrates three Eds communicating with a TRP 352 in the communication system 100, according to one embodiment. The three Eds are each illustrated as a respective different UE, and will be referred to as UEs 110x, 110y, and 110z. However, the Eds do not necessarily need to be UEs. In the following, the reference character 110 will be used when referring to any one of the UEs 110x, 110y, 110z, or any other UE (e.g. the UEs 110a-j introduced earlier).

The TRP 352 may be T-TRP 170 or NT-TRP 172. In some embodiments, the parts of the TRP 352 may be distributed. For example, some of the modules of the TRP 352 may be located remote from the equipment housing the antennas of the TRP 352, and may be coupled to the equipment housing the antennas over a communication link (not shown). Therefore, in some embodiments, the term TRP 352 may also refer to modules on the network side that perform processing operations, such as resource allocation (scheduling), message generation, encoding/decoding, etc., and that are not necessarily part of the equipment housing the antennas and/or panels of the TRP 352. For example, the modules that are not necessarily part of the equipment housing the antennas/panels of the TRP 352 may include one or more modules that: generate the downlink messages discussed herein, generate information related to paging (e.g. DCI scrambled by a paging ID and/or paging messages), schedule downlink transmissions (e.g. notifications in DCI or messages in a data channel) on configured resources in a control channel or data channel, generate scheduled downlink transmissions, process uplink transmissions (such as sensing feedback received from a UE 110), etc. The modules may also be coupled to other TRPs. In some embodiments, the TRP 352 may actually be a plurality of TRPs that are operating together to serve UEs 110, e.g. through coordinated multipoint transmissions among UEs and the TRPs.

The TRP 352 includes a transmitter 354 and receiver 356, which may be integrated as a transceiver. The transmitter 354 and receiver 356 are coupled to one or more antennas 358. Only one antenna 358 is illustrated. One, some, or all of the antennas may alternatively be panels. The processor 360 of the TRP 352 performs (or controls the TRP 352 to perform) much of the operations described herein as being performed by the TRP 352, e.g. generating the downlink message and/or DCI, generating information related to paging (e.g. DCI scrambled by a paging ID and/or paging messages), generating scheduled downlink transmissions, processing uplink transmissions (such as sensing feedback), etc. Generation of information for downlink transmission (e.g. generation of DCI or a downlink message) may include arranging the information in a message format, encoding the message, modulating, performing beamforming (as necessary), etc. Processing uplink transmissions (such as received sensing feedback) may include performing beamforming (as necessary), demodulating and decoding the received messages, etc. Decoding may be performed by a decoding method that decodes according to a channel coding scheme, e.g. polar decoding if the data is encoded using a polar code, low-density parity check (LDPC) decoding algorithm for a LDPC code, etc. Decoding methods are known. For completeness, example decoding methods that may be implemented include (but are not limited to): maximum likelihood (ML) decoding, and/or minimum distance decoding, and/or syndrome decoding, and/or Viterbi decoding, etc.

Although not illustrated, the processor 360 may form part of the transmitter 354 and/or receiver 356. The TRP 352 further includes a memory 362 for storing information (e.g. control information and/or data).

The processor 360 and processing components of the transmitter 354 and receiver 356 may be implemented by the same or different one or more processors that are configured to execute instructions stored in a memory (e.g. in memory 362). Alternatively, some or all of the processor 360 and/or processing components of the transmitter 354 and/or receiver 356 may be implemented using dedicated circuitry, such as a programmed FPGA, a GPU, or an ASIC.

If the TRP 352 is T-TRP 170, then the transmitter 354 may be or include transmitter 252, the receiver 356 may be or include receiver 254, the processor 360 may be or include processor 260 and may implement scheduler 253, and the memory 362 may be or include memory 258. If the TRP 352 is NT-TRP 172, then the transmitter 354 may be or include transmitter 272, the receiver 356 may be or include receiver 274, the processor 360 may be or include processor 276, and the memory 362 may be or include memory 278.

Each UE 110 (e.g. each of UEs 110x, 110y, and 110z) includes a respective processor 210, memory 208, transmitter 201, receiver 203, and one or more antennas 204 (or alternatively panels), as described earlier. Only the processor 210, memory 208, transmitter 201, receiver 203, and antenna 204 for UE 110x is illustrated for simplicity, but the other UEs 110y and 110z also include the same respective components.

The processor 210 performs (or controls the UE 110 to perform) much of the operations described herein as being performed by the UE 110, e.g. operating in a power-saving mode, receiving downlink messages, performing sensing, generating messages for uplink transmission (e.g. to provide the sensing feedback), etc. Decoding may be performed by a decoding method that decodes according to a channel coding scheme, e.g. polar decoding if the data is encoded using a polar code, LDPC decoding algorithm for a LDPC code, etc. Decoding methods are known. For completeness, example decoding methods that may be implemented include (but are not limited to): ML decoding, and/or minimum distance decoding, and/or syndrome decoding, and/or Viterbi decoding, etc. Generation of messages for uplink transmission may include arranging the information in a message format, encoding the message, modulating, performing beamforming (as necessary), etc.

Although not illustrated, the processor 210 may form part of the transmitter 201 and/or receiver 203.

The UE 110 further includes a sensor 205. Sensor 205 is a device or module whose purpose is to perform sensing. The implementation of the sensor 205 is application-specific and depends upon the object and/or condition being sensed. In some embodiments, the sensor 205 may control antenna 204 (or another antenna of the UE 110) to transmit a sensing signal, in which case the sensor 205 may be implemented by a processor for controlling transmission of the signal and/or an antenna for transmitting the sensing signal. The sensing signal may be an electromagnetic wave. For example, the sensing signal may be a radio wave, e.g. if RADAR is being used for the sensing. As another example, the sensing signal may be a light wave, e.g. if LiDAR is being used for the sensing. In some embodiments, the sensing signal may be a reference signal. In some embodiments, the sensor 205 may instead or additionally control antenna 204 (or another antenna of the UE 110) to receive the sensing signal, in which case the sensor 205 may be implemented by an antenna for receiving the sensing signal and/or a processor for measuring one or more parameters of the sensing signal (e.g. such as detected energy and/or amplitude and/or an angle of arrival of the sensing signal and/or time at which the sensing signal was received). In some embodiments, sensor 205 may be implemented by processor 210, transmitter 201, receiver 203, and/or antenna 204.

In some embodiments, the sensor 205 might also or instead sense a parameter measured by the sensor 205. For example, the sensor 205 might be a tactile sensor, or a strain sensor, or a humidity sensor, or a camera sensor (to take a digital image), etc. Although only one sensor 205 is illustrated, in general the UE 110 might have multiple sensors. For example, the UE 110 might have a camera to capture a digital image and an RF sensor for detecting reflections of waves. Additionally, or instead, a single sensor 205 might perform multiple different types of sensing.

The processor 210 determines feedback to send to the TRP 352 obtained from the sensing by the sensor 205. The feedback is implementation specific and depends upon the type of sensing performed and/or the information required by the TRP 352. In some embodiments, the feedback comprises a parameter directly measured by the sensing. For example, if the sensor 205 receives a sensing signal comprising reflected waves, the feedback may be a measured energy/amplitude and/or direction of one or more of the waves, and/or a relative or absolute time of arrival of one or more of the waves. In some embodiments, the feedback comprises information derived from the sensed parameter(s). For example, the feedback may comprise an indication of a location, speed, distance, orientation, shape and/or direction of travel of an object, where the location, speed, distance, orientation, shape and/or direction of travel of the object is determined by the processor 210 based on the sensing signal received by the sensor 205. For example, the UE 110 may implement RADAR and feedback the determined result (e.g. location of an object), rather than the measured parameters of the waves themselves.

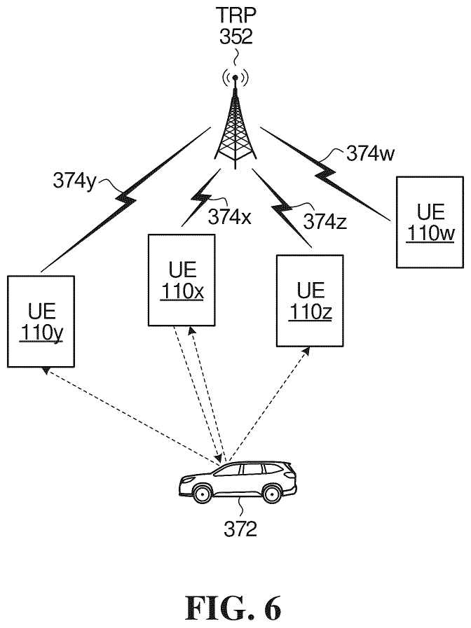

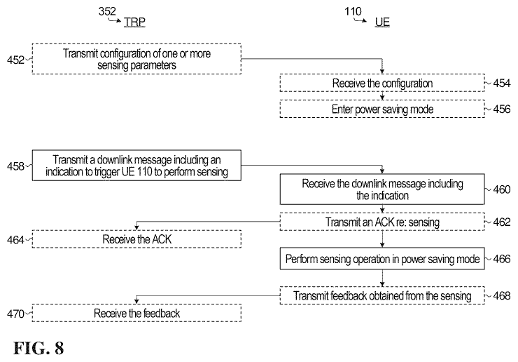

FIG. 6 illustrates UEs 110x, 110y, and 110z performing sensing of a target object 372, according to one embodiment. The UEs 110x, 110y, and 110z are each in communication with the TRP 352, e.g. via wireless links 374x, 374y, and 374z. UEs 110x, 110y, and 110z are also in the vicinity of target object 372. The TRP 352 wants to know certain properties related to the target object 372, e.g. the TRP 352 may want to determine at least one of the following properties related to the target object 372: position; size; moving direction; or material type (which may be based on reflection strength). Therefore, the TRP 352 triggers the UEs 110x, 110y, and 110z to each perform sensing, e.g. using a downlink message in the manner explained later in relation to FIG. 8. The UE 110x is configured to transmit a sensing signal, and UEs 110x, 110y, and 110z are each configured to receive the sensing signal, which will occur after reflection off of the target object 372. Each of UE 110x, 110y, and 110z receives the sensing signal and transmits feedback based on the received sensing signal, e.g. each UE may transmit the receive time, the detected energy, and the angle of arrival of the sensing signal, which the TRP 352 uses to determine the location and direction of movement of the target object 372. In the illustrated example, UE 110x is configured to perform monostatic sensing because it both transmits and receives the sensing signal (which may be optional depending on if UE 110x has a capability of processing full duplexed transmissions and receptions), whereas UEs 110y and 110z are each configured to perform bi-static sensing (i.e., sensing transmission and sensing reception are performed by separate nodes) because they only receive the sensing signal, not transmit the sensing signal. In a variation, the TRP 352 may transmit the sensing signal instead of or in addition to UE 110x, and/or the TRP 352 may also receive the sensing signal sent from UE 110x.

The TRP 352 does not need to trigger all UEs to participate in the sensing. For example, the TRP 352 may know the location of the UEs and the rough location of the target object 372 and may only trigger the UEs in the immediate vicinity of the target object 372 to perform sensing. In the example in FIG. 6, UE 110w is in communication with TRP 352 over wireless link 374w. However, UE 110w is not triggered to participate in the sensing. As the target object 374 and/or UEs move, the TRP 352 can dynamically determine and trigger different UEs to perform sensing.

### Sensing in a Power-Saving Mode

In some embodiments, a UE 110 may operate in a power-saving mode. In some embodiments, when operating in a power-saving mode, the UE 110 might not fully occupy the system resources available for downlink and/or uplink transmission, e.g. the UE might not utilize all transmission parameters and time-frequency resources available for downlink and/or uplink transmission. For example, the UE 110 might not constantly (or as often) monitor for network instructions on the downlink, e.g. the UE 110 might not monitor a control channel, such as the PDCCH, as often. For example, if the UE 110 is a reduced capacity (RedCap) commercial device, a wearable device, a low-cost industry wireless device, an IoT device, etc., then the UE 110 may operate in a power-saving mode much or all of the time. In some embodiments, the UE 110 might be deployed primarily for the purposes of sensing and therefore operate in a power-saving mode much or all of the time.

In some wireless communication systems, the UE 110 and network operate according to a radio resource control (RRC) protocol. The RRC protocol has different states in terms of the UE operating behaviour and radio resource usage. For example, the RRC protocol may include: an RRC Idle state in which there is no RRC connection established with the network and no actual RRC configured resources are used; an RRC Connected state (also referred to as “Active state”) in which an RRC connection is established and full RRC configured radio resources are used by the UE; and an RRC Inactive state in which partial RRC resources are reserved and the RRC functions of the UE may be reduced, e.g. to help save power. In some embodiments, the Idle and Inactive states may be considered power-saving modes. In some embodiments, a power-saving mode may include multiple actions that consume different amounts of power, but the mode as a whole may still be considered a power-saving mode. For example, in a power-saving mode the UE 110 may sleep (which consumes less power) but periodically wake up to receive a downlink message (e.g. during a paging occasion) and/or perform sensing and/or transmit feedback relating to the sensing. The different actions in the mode may consume different amounts of power, but the mode as a whole is a power-saving mode because on the whole the apparatus has reduced or limited power consumption and network resource usage compared to a state in which the UE 110 is actively connected to the network (e.g. power consumption may be reduced compared to the RRC Connected state).

In some embodiments, the power-saving mode is a mode in which the UE 110 has reduced or limited power consumption and network resource usage, and is associated with at least one of:
One or more RRC states, e.g. the power-saving mode may be an RRC Inactive state and/or an RRC Idle state.
An operation mode in which the UE 110 periodically wakes up from a sleep cycle to receive paging messages and/or other downlink notifications (e.g. associated with a paging occasion).
One or more channels, e.g. in terms of channel monitoring or processing. For example, the power-saving mode may be a mode having reduced monitoring occasions or increased monitoring periods to achieve power savings, e.g. in relation to any of the following channels: PDCCH only, PDSCH only, PDCCH with PDSCH, reference signal channel.
A reception bandwidth, e.g. the power-saving mode may be a mode in which the bandwidth for receiving communications is reduced.
A numerology, e.g. the power-saving mode may be a mode in which the subcarrier spacing (SCS) is fixed without dynamic configuration or switching indication.
A power control scheme, e.g. the power-saving mode may be a mode in which power is limited in a certain way, such as a limited maximum transmission power or through reduced functionality of the UE 110, e.g. the UE 110 may support limited downlink receptions.
A particular sleep mode, e.g. the power-saving mode may be a mode in which the UE 110 enters into a sleep mode, such as a deep sleep mode or a light sleep mode or a micro-sleep mode, where each type of sleep mode may be pre-defined (e.g. fixed or pre-configured) to associate traffic transmissions or receptions with one or more types of channels. The UE 110 may periodically wake up to receive a downlink message triggering sensing and/or to receive paging notifications/messages.

In some embodiments, after or upon completing initial access to connect to the network, the UE 110 enters a default power-saving mode. The UE 110 remains in the power-saving mode by default, and may temporarily enhance operation on demand, e.g. in response to being paged and/or in response a trigger from the TRP 352 to perform sensing. The enhanced operation may be performed in the power-saving mode.

In some embodiments, when the UE 110 is in a power-saving mode, monitoring of the downlink control channel, e.g. for DCI, might only be performed in a wake-up period, e.g. during the wake-up period of a discontinuous reception (DRX) cycle or DRX_on window. The wake-up period to perform this operation may be the enhanced operation mentioned above.

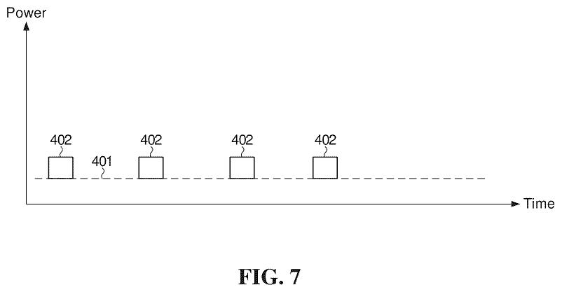

FIG. 7 illustrates power consumption for the UE 110 when operating in a power-saving mode, according to one embodiment. Within the power-saving mode, the UE 110 may operate in different operation modes, e.g., a default sleep mode, which is a very low power mode when in a sleep duration; and a wake-up mode, which is a low power mode when in a wake-up duration (e.g. when in a wake-up period of a DRX cycle). Although not shown, there may be other operations within the power-saving mode, e.g. a temporary higher power mode for transmitting and/or receiving a sensing signal, and/or for performing relatively short transmission of data, e.g. for transmitting feedback based on the sensing. The default sleep operation is indicated by dashed line 401. Periodic wake-up durations 402 are interspersed between the sleep durations, e.g. possibly at regular intervals, such as according to a DRX cycle. In a wake-up duration 402, the UE 110 consumes more power in order to perform operations such as monitoring for downlink massages. Each wake-up duration 402 might possibly be a wake-up period of a DRX cycle or DRX_on window, depending upon the implementation. Even though the UE 110 may perform some operations that have higher power than other operations (e.g. waking up in duration 402 compared to sleeping in duration 401), the UE 110 is still in a power-saving mode because the mode is one associated with reduced or limited power consumption as a whole, e.g. mostly sleeping. In some embodiments, the power-saving mode of FIG. 7 is an Inactive or Idle state, such as an RRC Inactive or RRC Idle state. In some embodiments, the transmitting or receiving of the sensing signals and/or transmitting the feedback obtained from the sensing also occurs within the power-saving mode, e.g. without transitioning to another state such as RRC Connected state.

FIG. 8 illustrates a method performed by TRP 352 and UE 110, according to one embodiment.

At step 452, the TRP 352 transmits a message to the UE 110 configuring one or more parameters relating to the sensing. For example, the UE 110 may be assigned an identifier (ID) that is associated with the UE 110 and used by the network to trigger the UE 110 to perform the sensing, e.g. the TRP 352 may use the ID to trigger the UE 110 to perform sensing by sending a downlink message including the ID. The ID may be UE-specific or a group ID shared by a group of UEs that can all be triggered to perform sensing. One or more other sensing parameters may additionally or instead be configured for UE 110 using the message transmitted in step 452.

In some embodiments, at least one of the following may be configured for the UE 110 in the message transmitted in step 452:
An ID associated with the UE 110 that is used to trigger the UE 110 to perform the sensing, as explained above.
A time and/or frequency resource for performing the sensing, e.g. the time-frequency resource at which the UE 110 is to transmit the sensing signal and/or receive the sensing signal when the UE 110 is triggered to perform sensing. In some embodiments, the bandwidth part (BWP) used for performing sensing (e.g. the BWP used for transmitting and/or receiving sensing signals) may be different from the BWP used for normal data communication (such as paged communication) between the UE and the network. For example, the sensing may be performed on a lower frequency band, e.g. a mmWave band.
Whether the UE 110 is to transmit a sensing signal or receive a sensing signal or both transmit a sensing signal and receive a sensing signal when the UE 110 is triggered to perform sensing.
An offset timing for starting the sensing, e.g. in terms of number of slots or time period between when the message is received triggering the UE 110 to perform sensing and when the sensing is to subsequently begin.
A sensing window, e.g. the time window in which the sensing signal is to be transmitted and/or received.
A sensing repeat pattern, e.g. the UE 110 may be configured to transmit and/or receive multiple sensing signals when triggered to perform sensing, perhaps each at different beam angles. The pattern of when to send/receive the sensing signals, how often, and/or the beam angles, etc. may be configured.
A sensing waveform.
A time and/or frequency resource for transmitting feedback obtained from the sensing.
Whether the UE 110 is to send an acknowledgement confirming that the UE 110 will perform the sensing (e.g. whether the UE 110 is to perform step 462 described later).
A first carrier frequency band (or component carrier) for downlink message monitoring and reception and a second carrier frequency band (or component carrier) for sensing transmission or reception, where the first carrier frequency band (or component carrier) and the second carrier frequency band (or component carrier) may or may not be the same; for example, the first carrier frequency band is a lower frequency carrier such as below 6 GHz, and the second carrier frequency band is a higher frequency carrier such as above 6 GHz.

Not all of the parameters discussed above are necessarily indicated in the message transmitted in step 452. For example, some may be preconfigured or fixed, e.g. in a standard. As another example, some may instead be transmitted in the downlink message in step 458, described later.

At step 454 the UE 110 receives the message configuring the one or more parameters. At step 456, the UE 110 then enters a power-saving mode. Note that the configuration described above in relation to steps 452 and 454 may occur before the UE 110 enters the power-saving mode, which is the example illustrated because step 456 happens after step 454. Alternatively, one, some, or all of the parameters may be configured as part of the transition of the UE 110 into the power-saving mode. For example, the configuration may be included in, e.g., an RRC-Release message to instruct UE 110 to transition from Connected state/mode to a power-saving mode/state (Inactive state or Idle state). For example, steps 452 and 454 may be part of step 456. As an example, the UE 110 may be triggered to enter the power-saving mode, and as part of the message triggering the UE 110 to enter the power-saving mode and/or in a subsequent message during the transition the TRP 352 may transmit to the UE 110 an indication of the parameters to be configured. In some embodiments, one, some, or all of the parameters to be configured might occur in the power-saving mode, i.e. after step 456, depending upon the implementation.

In any case, regardless of whether the configuration in steps 452/454 occurs before the power-saving mode, as part of the transition of the UE 110 into the power-saving mode, or perhaps in the power-saving mode, the configuration may be transmitted in different ways. In some embodiments, the configuration is sent in higher-layer signaling, such as in RRC signaling or in a MAC CE. In some embodiments, the configuration may occur in one or more messages sent during an initial access procedure, such as in system information (SI), e.g. in a master information block (MIB) or system information block (SIB). Therefore, in some embodiments, the message sent in step 452 may be an RRC message, a MAC CE, or SI. In some embodiments, the message sent in step 452 can be in group-cast signaling for more than one UE.

At some point after the UE 110 enters the power-saving mode, the network is to trigger the UE 110 to perform sensing. Therefore, at step 458 the TRP 352 transmits a downlink message which includes an indication used for triggering the UE 110 in the power-saving mode to perform sensing. At step 460, the UE 110 receives the downlink message in the power-saving mode. The UE 110 may decode the downlink message to obtain the indication used for triggering the UE 110 to perform the sensing. As explained later, in some embodiments, the downlink message may be associated with paging. As an example, the downlink message may be a paging message (such as the enhanced paging message described later) supplemented with the indication used for triggering the UE 110 to perform sensing. The paging message may also page one or more UEs, i.e. indicate to one or more UEs that there is data to send to the one or more UEs. In some embodiments, to obtain the downlink message the UE 110 may: (1) receive DCI scrambled by an ID also used for paging (e.g. a P-RNTI), (2) obtain from the DCI a time-frequency location for the downlink message, and (3) receive the downlink message at that time-frequency location.

At step 462, the UE 110 may transmit, to TRP 352, an acknowledgement (ACK) that the UE 110 will perform the sensing. The ACK may be sent, for example, in a short data transmission (SDT), e.g. on a grant-free resource or via 2-step RACH procedure. The TRP 352 receives the ACK at step 464. Steps 462 and 464 may be beneficial in implementations in which the UE 110 has the choice of whether or not to perform sensing. There might be situations in which the UE 110 should not or cannot perform sensing, e.g. if the UE 110 has very low battery power or the UE 110 is engaged in another temporary processing task. If the UE 110 is not going to perform the requested sensing, the UE 110 can either not send the ACK at step 462 or instead send a negative acknowledgement (NACK). The ACK or NACK may optionally be sent with a UE sensing ID (or UE I-RNTI) configured by network, e.g., configured at step 452 or during the UE transition from Connected state to a power-saving mode/state. The TRP 352 may interpret the ACK received at step 464 as an indication that the UE 110 will perform the sensing, and may interpret the absence of an ACK within a certain time window, or the receipt of a NACK, as an indication that the UE 110 will not perform the sensing. If the TRP 352 does not receive an ACK, then depending upon the implementation or scenario the TRP 352 may try to trigger another UE instead to perform sensing. In the illustrated method, the UE 110 is triggered to perform sensing and agrees to perform sensing.

Besides triggering the UE 110 to perform sensing, the downlink message transmitted in step 458 and received in step 460 might also configure one or more parameters related to the sensing or provide other information. For example, in some embodiments the downlink message may include an indication of at least one of the following:
A time and/or frequency resource for performing the sensing, e.g. the time-frequency resource at which the UE 110 is to transmit the sensing signal and/or receive the sensing signal. As previously mentioned, in some embodiments the BWP used for performing sensing may be different from the BWP used for normal data communication, e.g. the sensing may be performed on a lower frequency band.
Whether the UE 110 is to transmit a sensing signal or receive a sensing signal or both transmit a sensing signal and receive a sensing signal.
An offset timing for starting the sensing, e.g. in terms of number of slots or time period between when the message is received triggering the UE 110 to perform sensing and when the sensing is to subsequently begin.
A sensing window, e.g. the time window in which the sensing signal is to be transmitted and/or received.
A sensing repeat pattern, e.g. the UE 110 may be configured to transmit and/or receive multiple sensing signals when triggered to perform sensing, perhaps each at different beam angles. The pattern of when to send/receive the sensing signals, how often, and/or the beam angles, etc. may be configured.
A sensing waveform.
A time-frequency resource for transmitting feedback obtained from the sensing.
Whether the UE 110 is to send an acknowledgement confirming that the UE 110 will perform the sensing (e.g. whether or not the UE 110 is to perform step 462).
A location associated with a target object to be sensed.
A beam direction for transmitting a sensing signal.
A beam direction for receiving a sensing signal.
A carrier frequency band or component carrier for sensing signal transmission or reception.

Not all of the parameters discussed above are necessarily indicated in the downlink message. For example, some may be preconfigured or fixed, e.g. in a standard. As another example, some may have instead been indicated in the configuration sent in step 452. The benefit of providing the indication in the downlink message is that the indicated parameter may be changed dynamically, e.g. a different configuration may possibly be indicated each time the UE 110 is triggered to perform sensing. For example, the network could dynamically decide, just before triggering the UE 110 to perform sensing, whether the UE 110 should transmit a sensing signal or receive a sensing signal, e.g. depending upon the UE's location compared to the target object to be sensed. The downlink message could indicate to the UE 110 whether the UE 110 is to transmit the sensing signal or receive the sensing signal. The benefit of instead indicating the configuration in the message sent in step 452 is that it may be indicated semi-statically, e.g. in higher-layer signaling, and then used each time the UE 110 is triggered to perform sensing by the downlink message. For example, if the UE 110 will always just receive a sensing signal, then the UE 110 may be configured to just receive sensing signals in the message sent in step 452 before the UE 110 enters the power-saving mode or as part of the transition into the power-saving mode. The UE 110 can then be triggered to perform sensing in the power-saving mode via the downlink message, but the downlink message does not have to indicate whether the UE 110 is to transmit or receive a sensing signal during the sensing because the UE 110 is previously configured to just receive sensing signals. Signaling overhead may therefore be saved in the downlink message.

In step 466, in response to receiving the indication triggering the UE 110 to perform sensing, the UE 110 performs the sensing in the power-saving mode. Performing the sensing in the power-saving mode may include at least one of transmitting a sensing signal or receiving a sensing signal. That is, depending upon how the UE 110 is configured, the UE 110 might only transmit a sensing signal or might only receive the sensing signal, or might both transmit and receive the sensing signal, e.g. in time-frequency resources pre-configured or dynamically indicated in the downlink message. The received sensing signal may be after a reflection off of a target object, like in the example explained earlier in relation to FIG. 6. In the example in FIG. 6, UE 110x, 110y, and 110z are each triggered to perform sensing. UE 110x performs the sensing by both transmitting and receiving the sensing signal. UE 110y and UE 110z perform sensing by just receiving the sensing signal.

In the method of FIG. 8 the UE 110 performs the sensing while still in the power-saving mode. There is no transition to another state that is not a power-saving mode, e.g. there is no transition to an RRC Connected state to perform the sensing. In some embodiments, transmission synchronization or timing reference used by UE 110 for sensing signal transmission or reception in a power-saving mode is based on network broadcast signaling (e.g., SI or SSB) or a common reference signal from the network. In a variation of FIG. 8, the UE 110 could instead first transition out of the power-saving mode before performing the sensing, e.g. transition to an RRC Connected state. However, this delays the sensing operation and also consumes more power. Therefore, there is a benefit of reduced latency and lower power for the UE 110 to perform the sensing in the power-saving mode. As an example, the UE 110 may be asleep and wake up during a paging occasion. During the paging occasion, the UE 110 may be triggered to perform sensing in a downlink message that is associated with paging, e.g. in the various ways described herein. The UE 110 may then perform the sensing and transmit feedback obtained from the sensing in a short message during the wake-up period (e.g. in an uplink control channel, such as a PUCCH), and then immediately go back to sleep, thereby always staying in the power-saving mode.

At step 468, the UE 110 transmits the feedback obtained from the sensing. As described above, the feedback might include one or more parameters directly measured by the sensing (e.g. a measured energy/amplitude, angle of arrival, and detection time), and/or the feedback might include one or more items of information derived based on the parameters directly measured, e.g. an indication of location or speed of the target object. In some embodiments, the feedback may be transmitted on a control channel, such as a PUCCH. In some embodiments, the feedback may be transmitted in a grant-free transmission and/or on contention-based resources. In some embodiments, the resources for transmitting the feedback may be granted.

At step 470, the TRP 352 subsequently receives the feedback from the UE 110.

In some embodiments, step 468 is also performed in a power-saving mode. That is, the UE 110 both performs the sensing and transmits the feedback while in the power-saving mode. In other embodiments, the feedback might be transmitted at a later point, e.g. after the UE 110 transitions out of the power-saving mode. This might be the case if, for instance, in the power-saving mode the UE 110 does not have the ability to send uplink communications.

Many of the steps of FIG. 8 are indicated as optional by the presence of a stippled box. For example, the method might not begin until a later time after the UE 110 has already entered the power-saving mode, which is why steps 452, 454, and 456 are indicated as optional. As another example, the UE 110 might be configured to not send an ACK indicating that the UE 110 will perform the sensing, which is why steps 462 and 464 are omitted. Steps 462 and 464 may be omitted in situations in which the UE 110 does not have a choice as to whether the UE 110 will perform sensing and/or in situations in which to save overhead the TRP 352 does not require an indication of whether the UE 110 will perform the sensing (e.g. if the TRP 352 never receives feedback from the UE 110 based on the sensing the TRP 352 may treat that as an indication that the UE 110 did not perform sensing). Whether or not the UE 110 is to send an ACK confirming it will perform sensing, i.e. whether or not the UE 110 is to perform step 462, may be configured in the message transmitted in step 452 or in the downlink message transmitted in step 458, or the configuration may be predefined/fixed. Steps 468 and 470 are also optional because there may be implementations in which the UE 110 does not necessarily send feedback obtained by the UE 110, e.g. maybe the UE 110 uses the sensed information itself (e.g. to guide its next operation). Alternatively, the UE 110 might send the feedback, but not necessarily right away. In some embodiments, the UE 110 might transmit the feedback to another device other than the TRP 352, e.g. the UE 110 might transmit the feedback to another UE, in which case step 468 may be included in the method of FIG. 8, but step 470 would be omitted. Whether the UE 110 is to transmit the feedback or not, and/or the entity to which the UE 110 is to transmit the feedback, may be configurable. For example, it may be configured in the message transmitted in step 452 or the downlink message transmitted in step 458.

The method of FIG. 8 is shown in relation to a single UE 110. However, in some embodiments the downlink message may be transmitted to multiple UEs, e.g. in a broadcast or groupcast message besides paging. For example, a group of UEs might each use a common ID to descramble DCI in a control channel that schedules the downlink message for those UEs. The downlink message is then decoded by each UE in the group. Each UE then reviews the downlink message to see if the UE is triggered to perform sensing.

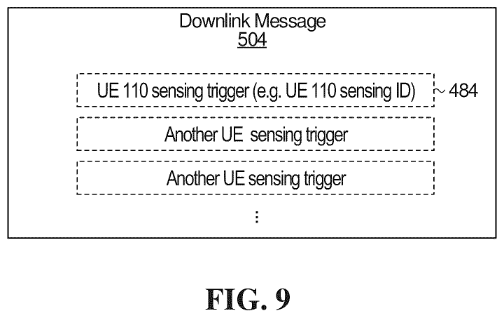

One example of a downlink message that may be transmitted in step 458 of FIG. 8 is illustrated in FIG. 9. The downlink message 504 includes the indication 484 triggering UE 110 to perform sensing, e.g. the indication may be an identifier (“sensing ID” in FIG. 9) that is associated with the UE 110 and that, when present in the downlink message 504 triggers the UE 110 to perform sensing. Optionally, the downlink message 504 may further include one or more other IDs triggering other UEs to perform sensing. For example, in the example of FIG. 6 three UEs may be triggered to perform sensing (UE 110x, UE 110y, and UE 110z). In some embodiments, there could be a single ID that is shared by a group of UEs and that, when present in the downlink message, triggers all those UEs to perform sensing. In some embodiments, each UE may be triggered via its own unique sensing ID. Any variation in between is also possible. Therefore, in some embodiments, the downlink message 504 may include multiple IDs to trigger multiple UEs to perform the sensing, the multiple IDs each associated with a respective different one or more of the UEs, and the multiple IDs including an ID associated with at least the UE 110 that triggers the UE 110 to perform the sensing.

Although not illustrated in FIG. 9, the downlink message 504 may include an indication of one or more sensing parameters or information discussed above in relation to FIG. 8, e.g.: an indication of a time-frequency resource for performing the sensing; and/or whether the UE 110 is to transmit the sensing signal or receive the sensing signal or both transmit the sensing signal and receive the sensing signal; and/or an offset timing for starting the sensing; and/or a sensing window; and/or a sensing repeat pattern; and/or a sensing waveform; and/or a time-frequency resource for transmitting feedback obtained from the sensing; and/or whether the UE is to send an acknowledgement confirming that the apparatus will perform the sensing; and/or a location associated with a target object to be sensed; and/or a beam direction for transmitting the sensing signal; and/or a beam direction for receiving the sensing signal; and/or a carrier frequency band or component carrier for sensing operation. Some of these parameters might be indicated on a UE-by-UE specific basis, e.g. it may be indicated, for each UE, whether that UE is to transmit a sensing signal, receive a sensing signal, or both. Other parameters might be indicated once and be common to all UEs being triggered to perform the sensing, e.g. a frequency band or component carrier for sensing operation or an indication of a rough location of the target object may be indicated once in the downlink message 504 and be used by all UEs. In some embodiments, the downlink message 504 includes the location associated with the target object, and the location is provided in a field that is common to all UEs triggered to perform the sensing.

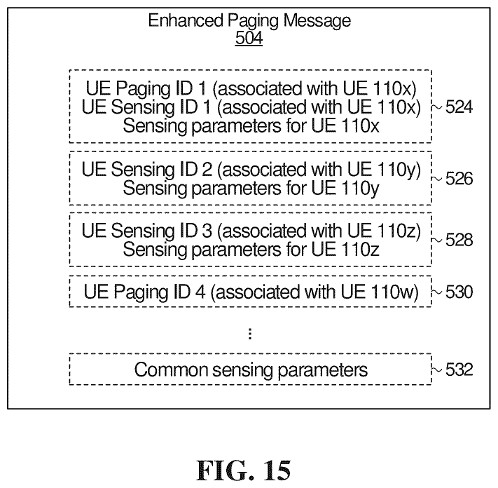

Although not illustrated in FIG. 9, the downlink message 504 may additionally or instead include paging information for paging one or more UEs. The enhanced paging message described later in relation to FIG. 15 is an example of such a downlink message.

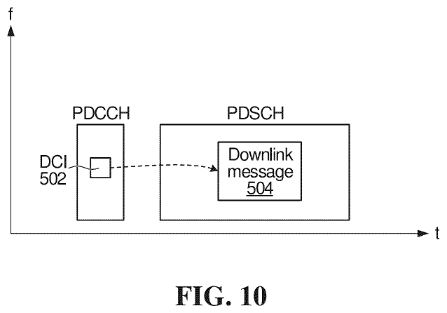

FIG. 10 illustrates one example way in which downlink message 504 may be transmitted in step 458 and received in step 460 of FIG. 8. The UE 110 monitors a control channel for control information during a monitoring occasion, e.g. possibly in a wake-up duration of the power-saving mode. In some embodiments, the monitoring occasion may be a paging occasion. The control channel monitored during the monitoring occasion is illustrated as a PDCCH, and the control information is illustrated as DCI 502. The DCI 502 is transmitted by the TRP 352 and decoded by the UE 110. The DCI 502 schedules the downlink message 504 in a data channel, which is illustrated as a PDSCH. The downlink message 504 is decoded by the UE 110 to obtain the indication in the downlink message that triggers the UE 110 to perform sensing. The downlink message 504 may also indicate the other information/parameters discussed above in relation to FIGS. 8 and 9. In the example of FIG. 10, the step of receiving the downlink message 504 includes the UE 110: receiving DCI 502, obtaining from the DCI 502 an indication of the time-frequency location of the downlink message 504 in the data channel, and receiving the downlink message 504 at that time-frequency location in the data channel. That is, the TRP 352 does not just transmit the downlink message 504, but also transmits DCI 502 including an indication of the time-frequency resource at which the downlink message 504 is located. As shown in other examples below, the downlink message 504 may be associated with paging, e.g. the DCI 502 may be a paging notification and/or the DCI 502 may be sent during a paging occasion and/or the DCI 502 may be scrambled (e.g. have its CRC scrambled) by an ID also used for paging (such as a P-RNTI), and/or the downlink message 504 may also include paging information (e.g. the downlink message may be a paging message supplemented with the indication triggering the UE 110 to perform sensing), and/or the DCI 502 may also schedule a paging message, etc.

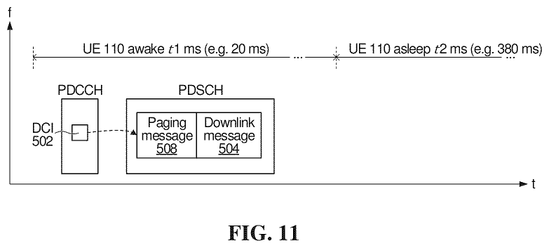

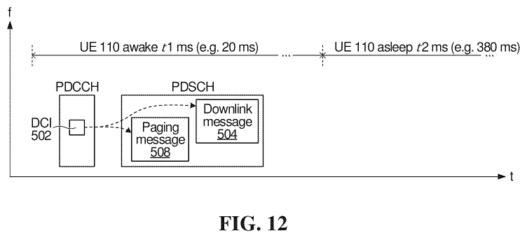

FIG. 11 illustrates another example way in which downlink message 504 may be transmitted in step 458 and received in step 460 of FIG. 8. The UE 110 is in a power-saving mode in which there are wake-up durations and sleep durations. In the illustrated example, the wake-up duration is 20 ms and the sleep duration is 380 ms. This is only an example. The wake-up duration and/or sleep duration may be different lengths, or in some implementations there might not even be separate wake-up and sleep duration in the power-saving mode. In the illustrated wake-up duration, the UE 110 monitors a control channel for control information during a monitoring occasion. The monitoring occasion may be a paging occasion. The control channel monitored during the monitoring occasion is illustrated as a PDCCH, and the control information is illustrated as DCI 502. The DCI 502 is transmitted by the TRP 352 and decoded by the UE 110. The DCI 502 schedules both a paging message 508 and downlink message 504. The messages are scheduled in a data channel, which is illustrated as a PDSCH. The downlink message 504 is decoded by the UE 110 to obtain the indication in the downlink message that triggers the UE 110 to perform sensing. The UE 110 may also decode the paging message 508, e.g. if the UE 110 is being paged or if the UE 110 needs to check whether it is being paged. The UE 110 might not decode the paging message in certain situations, e.g. if the UE 110 is configured to only perform sensing and cannot or is never paged, or if the DCI includes one or more bits indicating that the UE 110 is not being paged. The downlink message 504 decoded by the UE 110 may also indicate the other information/parameters discussed above in relation to FIGS. 8 and 9. In the example of FIG. 11, the step of receiving the downlink message 504 includes the UE 110: receiving DCI, obtaining from the DCI an indication of the time-frequency location of the downlink message 504 in the data channel, and receiving the downlink message 504 at that time-frequency location in the data channel. The downlink message 504 is associated with paging in that the DCI also schedules a paging message 508. It might be the case, for example, that the DCI has its CRC scrambled by an ID that is a paging ID, e.g. a P-RNTI. The paging message 508 and the downlink message 504 may be scheduled in a single set of time-frequency resources, e.g. the downlink message 504 may be appended to the paging message 508 (as illustrated in FIG. 11) or otherwise integrated or multiplexed with the paging message 508. FIG. 12 is a variation of FIG. 11 illustrating the fact that the DCI 502 could instead separately schedule the paging message 508 and downlink message 504 at two different time-frequency resources.

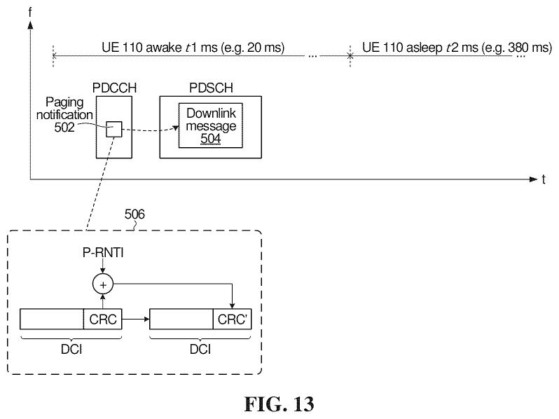

FIG. 13 illustrates another example way in which downlink message 504 may be transmitted in step 458 and received in step 460 of FIG. 8. The UE 110 is in a power-saving mode in which there are wake-up durations and sleep durations. In the illustrated example, the wake-up duration is 20 ms and the sleep duration is 380 ms. This is only an example. The wake-up duration and/or sleep duration may be different lengths, or in some implementations there might not even be separate wake-up and sleep duration in the power-saving mode. In the illustrated wake-up duration, the UE 110 monitors a control channel during a paging occasion for DCI carrying a paging notification 502. The control channel is illustrated as a PDCCH. The paging notification 502 is transmitted by the TRP 352 and decoded by the UE 110. The paging notification 502 schedules a downlink message 504 triggering the apparatus 110 to perform sensing. The message is scheduled in a data channel, which is illustrated as a PDSCH. The downlink message 504 is decoded by the UE 110 to obtain the indication in the downlink message that triggers the UE 110 to perform sensing. The paging notification 502 has its DCI scrambled by a paging specific ID, which may be a P-RNTI. In stippled box 506 the DCI is illustrated in more detail. It includes a CRC. It is the CRC part of the DCI that is scrambled. The scrambling occurs by performing an XOR with a P-RNTI.

Although not illustrated in FIG. 13, the paging notification 502 might also schedule a paging message, e.g. if there were also UEs to be paged. However, this is not necessary, e.g. if network only wants to trigger sensing and not page during a particular paging occasion. Also or instead, although not illustrated in FIG. 13, the downlink message 504 might include paging information in addition to triggering UE 110 to perform sensing. For example, the downlink message 504 may page one or more UEs.

In a further variation of FIG. 13, DCI 502 may be transmitted that is not necessarily called a paging notification, and/or the ID used to scramble the CRC part of the DCI is not necessarily a P-RNTI.

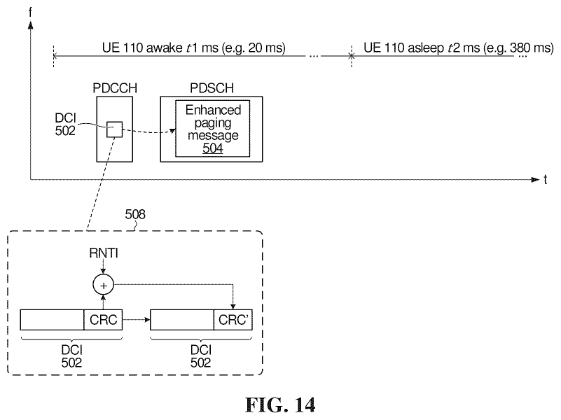

FIG. 14 illustrates another example way in which downlink message 504 may be transmitted in step 458 and received in step 460 of FIG. 8. The UE 110 is in a power-saving mode in which there are wake-up durations and sleep durations. In the illustrated example, the wake-up duration is 20 ms and the sleep duration is 380 ms. This is only an example. The wake-up duration and/or sleep duration may be different lengths, or in some implementations there might not even be separate wake-up and sleep duration in the power-saving mode. In the illustrated wake-up duration, the UE 110 monitors a control channel for DCI 502 during a monitoring occasion. The monitoring occasion may be a paging occasion. The control channel is illustrated as a PDCCH. In some embodiments, the DCI 502 may be a paging notification. The DCI 502 is transmitted by the TRP 352 and decoded by the UE 110. The DCI 502 schedules a downlink message 504 referred to as an enhanced paging message 504 because it is a paging message that is supplemented with the indication used for triggering the UE 110 to perform sensing. The enhanced paging message 504 is scheduled in a data channel, which is illustrated as a PDSCH. The enhanced paging message 504 is decoded by the UE 110 to obtain the indication that triggers the UE 110 to perform sensing. The DCI 502 is scrambled by an ID illustrated in stippled bubble 508 as an RNTI. The RNTI may be paging specific (e.g. a P-RNTI) or a new type of ID related to sensing and paging, e.g. a Sensing-P-RNTI. In stippled box 508 the DCI 502 is illustrated in more detail. It includes a CRC. It is the CRC part of the DCI 502 that is scrambled. The scrambling occurs by performing an XOR with the RNTI.

One example of enhanced paging message 504 is illustrated in FIG. 15. In the example, it is assumed that UEs are being triggered to perform the sensing illustrated in FIG. 6. UE 110 of FIG. 8 may be any one of the UEs 110x, 110y, or 110z triggered to perform sensing. Also, in the enhanced paging message 504 of FIG. 15 it is assumed that some of the UEs are also being paged. As shown 524, the enhanced paging message 504 includes a UE Paging ID 1 that is associated with UE 110x. The presence of UE Paging ID 1 means that UE 110x is being paged. In response, UE 110x may take the steps required when being paged, e.g. perform a network access procedure (e.g. an initial network access procedure) to synchronize and transmit/receive data messages to/from the TRP 352. The network access procedure may include a radio access channel (RACH) procedure.

The presence of UE sensing ID 1 acts as the trigger that triggers to UE 110x to perform sensing. If UE sensing ID 1 was not present, then UE 110x would still be paged but would not be triggered to perform sensing. Sensing parameters may also be configured for UE 110x. Examples of sensing parameters are described earlier and may include: an indication of a time-frequency resource for performing the sensing; and/or whether the UE 110x is to transmit the sensing signal or receive the sensing signal or both transmit the sensing signal and receive the sensing signal; and/or an offset timing for starting the sensing; and/or a sensing window; and/or a sensing repeat pattern; and/or a sensing waveform; and/or a time-frequency resource for transmitting feedback obtained from the sensing; and/or whether the UE 110x is to send an acknowledgement confirming that the UE 110x will perform the sensing; and/or a beam direction for transmitting the sensing signal; and/or a beam direction for receiving the sensing signal. The sensing parameters indicated at 524 are specific to UE 110x and, if desired, the network may dynamically change/indicate these parameters for UE 110x anytime the UE 110x is triggered to perform sensing. As an example, each time UE 110x is triggered to perform sensing, the network may indicate a beam direction for receiving the sensing signal that is commensurate with the location of UE 110x relative to the rough location of the target.

As shown 526, the enhanced paging message 504 further includes a UE Sensing ID 2 that is associated with UE 110y. The presence of UE sensing ID 2 acts as a trigger to trigger UE 110y to perform sensing. There is no paging ID associated with UE 110y, so UE 110y is not being paged. Instead, UE 110y is just being triggered to perform sensing. Sensing parameters may also be configured of UE 110y.

As shown at 528, the enhanced paging message 504 further includes a UE Sensing ID 3 that is associated with UE 110z. The presence of UE sensing ID 3 acts as a trigger to trigger UE 110z to perform sensing. There is no paging ID associated with UE 110z, so UE 110z is not being paged. Instead, UE 110z is just being triggered to perform sensing. Sensing parameters may also be configured of UE 110z.

As shown at 530, the enhanced paging message 504 further includes a UE paging ID 4 that is associated with UE 110w. The presence of UE paging ID 4 acts as a page for UE 110w. In response, UE 110w may take the steps required when being paged, e.g. perform a network access procedure (e.g. an initial network access procedure). UE 110w is not being triggered to perform sensing, and so there is no sensing ID for UE 110w included in the enhanced paging message 504.

In some embodiments, UE sensing ID 1, UE sensing ID 2, and UE sensing ID 3 may be the same ID if the UEs are part of a sensing group that is triggered to perform sensing together.

The enhanced paging message 504 includes sensing parameters that are configured for each of UE 110x, 110y, and 110z. These may be parameters that not common to all the UEs but are set on a UE-specific basis. On example might be an indication of whether the UE is to transmit a sensing signal, receive a sensing signal, or both transmit and receive a sensing signal. Another example might be an indication of a beam direction for transmitting and/or receiving the sensing signal. However, as shown at 532 there may be one or more other sensing parameters or information that are common to all the UEs performing sensing. These need only be indicated once, e.g. in a field that is common to all the UEs. One example may be an indication of the location of the target object. Another example may be offset timing for starting the sensing, e.g. the number of slots between when the enhanced paging message 504 is received and when the UEs are to subsequently start performing the sensing.

In one specific example, the following is common to all UEs performing sensing and indicated in at 532: a carrier frequency band/component carrier, offset timing for starting the sensing and an indication of the rough location of the target object 372. The following is indicated on a UE-by-UE specific basis for each UE that is triggered to perform the sensing (e.g. at 524 for UE 110x, at 526 for UE 110y, etc.): whether the UE is to transmit, receive, or both transmit and receive a sensing signal; and whether the UE is to acknowledge that sensing will be performed (i.e. step 462 of FIG. 8). Other sensing parameters (e.g. the time-frequency resources used to perform the sensing) are indicated in advance, e.g. in the message transmitted in step 452 of FIG. 8.

In another specific example, the following is common to all UEs performing sensing and indicated in at 532: a carrier frequency band/component carrier, offset timing for starting the sensing, an indication of the rough location of the target object 372, a time-frequency resource or resource indication for performing the sensing, and a sensing window or sending period for performing the sensing. The following is indicated on a UE-by-UE specific basis for each UE that is triggered to perform the sensing (e.g. at 524 for UE 110x, at 526 for UE 110y, etc.): whether the UE is to transmit, receive, or both transmit and receive a sensing signal, and whether the UE is to acknowledge that sensing will be performed (i.e. step 462 of FIG. 8). Other sensing parameters that may be needed by the UEs are indicated in advance, e.g. in the message transmitted in step 452 of FIG. 8.

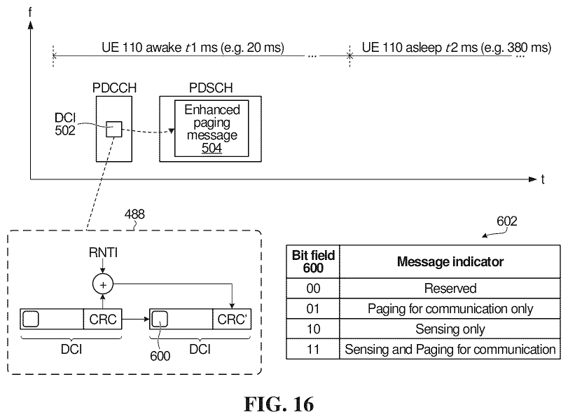

In some embodiments, the DCI 502 scheduling the downlink message transmitted in step 458 of FIG. 8 may include an indication of whether the downlink message triggers sensing only or only pages UEs, or both triggers sensing and pages UEs. FIG. 16 is an example in which the downlink message is enhanced paging message 504 scheduled by DCI 502. The DCI 502 includes a bit field 600 of two bits that indicate whether the enhanced paging message 504 only triggers sensing, only pages for communication, or both triggers sensing and paging for communication. Table 602 is one example of how the two bits may map to the different scenarios. Since the enhanced paging message 504 illustrated in FIG. 15 both triggers sensing and pages, bit field 600 would have bits 11. The drawback of including field 600 in the DCI is that it is additional information that needs to be transmitted in DCI. The benefit is that it may save UEs from unnecessarily decoding the enhanced paging message 504. For example, if UE 110y and UE 110z are devices that are only configured for performing sensing (e.g. they are low-power low-cost sensors), then if the field 600 has bit 01 indicating that the enhanced paging message 504 is for paging only, the UEs 110y and 110z know they do not need to decode the enhanced paging message 504. Similarly, if UE 110w is a mobile phone that does perform sensing but can be paged, then if the field 600 has bit field 10 indicating that the enhanced paging message 504 is for sensing only, the UE 110w knows it does not have to decode the enhanced paging message 504.

In a variation of FIG. 16, the downlink message does not have to be the enhanced paging message 504 explained above (e.g. in relation to FIG. 15). Instead, the downlink message may be the downlink message 504 illustrated in FIG. 9 supplemented with paging information when UEs are to be paged.

In embodiments in which the UE 110 monitors a control channel for DCI scheduling a downlink message, e.g. in any of the embodiments illustrated in FIGS. 10 to 16, there is wasted overhead associated with detecting/decoding the DCI if there is no notification for the UE 110 scheduling the downlink message. For example, for each monitoring occasion (e.g. paging occasion) in which DCI may be sent scheduling a downlink message, the UE 110 may need to perform blind detection as follows: for each PDCCH candidate in the control channel, the UE 110 attempts to decode the DCI 502 carried by the PDCCH candidate, unscrambles the CRC value of the DCI 502 using an ID (e.g. the P-RNTI or Sensing-P-RNTI), and checks if the CRC value is valid. If the CRC value is not valid, the UE 110 assumes there is no valid DCI 502 scheduling downlink message 504. The detection was unnecessary. To try to reduce the overhead associated with unnecessary detection of DCI during each monitoring occasion, the UE 110 may be configured to monitor for an early notification message, e.g. a paging early indication (PEI) message, such as one transmitted in DCI format DCI 2_7. The early notification message may have a separate monitoring cycle, e.g. one PEI cycle may include several paging cycles so that a PEI message may be able to instruct one or more UEs to skip multiple paging cycles. In such an early indication, the DCI format like DCI 2_7 in NR network can be specially designed DCI with low-power consumption and reception only by the UE before actual paging occasions arrive.

One example is as follows. The UE 110 is in a sleep mode and is configured to wake up during paging occasions and monitor for a notification in DCI (e.g. a paging notification) that schedules a downlink message indicating paging and/or triggering sensing. At a point in time in advance, the UE 110 first decodes an early notification message, such as a PEI, e.g. in DCI such as in DCI 2_7. The early notification message indicates whether subsequent paging occasions have a message for UE 110 paging and/or triggering the UE to perform sensing. If not, then the UE 110 can skip those paging occasion(s) and remain in a sleep mode. As an example, the early notification message may include a field indicating that UE 110 is to skip a particular number of subsequent paging occasions, where the number may, for example, be between 1 and N_{PO}^{PEI}, where N_{PO}^{PEI} is configured in advance, e.g. semi-statically using higher-layer signaling. UE 110 may be part of a group or subgroup of UEs. There may be N_{SG}^{PO} subgroups, each having a unique ID. The early notification message may also include the ID of the subgroup or IDs of the subgroups that are to skip one or more paging occasions, or vice versa. In some embodiments, the early notification message may include one or more bits to indicate whether a UE, a group of UEs, or a subgroup of UEs will be paged or triggered to perform sensing in an upcoming one or more paging occasions. If the early notification indicates paging only, and a particular UE is only configured to perform sensing and knows it cannot be paged, then that UE may skip the paging occasion(s) and stay asleep.

By implementing the early notification message described above, UE operations may possibly be reduced by avoiding the UE unnecessarily trying to detect/decode DCI in a paging occasion when the UE knows it will not be paged or triggered to perform sensing. In some embodiments, the UE subgroups associated with sensing may be different from the UE subgroups associated with paging, which allows the early notification message more flexibility in designating certain UEs to skip certain paging occasions in different scenarios. In other embodiments, the UE subgroups are the same for both paging and sensing, e.g. if any UE in the subgroup will either be paged or triggered to sense in an upcoming paging occasion, then that subgroup is instructed in the early notification message not to skip the upcoming paging occasion.

In view of the above, in some embodiments of the method of FIG. 8 the downlink message is associated with a paging occasion, and the method further includes: (1) the UE 110 decoding control information prior to the paging occasion, e.g. the UE decoding the early notification message sent in DCI such as a PEI; (2) the UE 110 obtaining, from that control information, an indication of whether or not the UE 110 will be triggered to perform the sensing during the paging occasion; and (3) receiving the downlink message only in response to the control information indicating that the UE 110 will be triggered to perform the sensing during the paging occasion. Steps (1) and (2) may be performed between steps 456 and 458 of FIG. 8.

### Additional Variations

In some embodiments of the method of FIG. 8, resources for performing the sensing may be configured in advance for UE 110, e.g. in the message transmitted in step 452 before the UE 110 enters the power-saving mode or during the transition of the UE 110 into the power-saving mode. Then, when the UE 110 is triggered to perform sensing, the downlink message might only include minimal content related to the sensing, e.g. the downlink message might only include the ID associated with UE 110 to trigger the UE 110 to perform the sensing. The trigger can act as an “activation” of the resources previously configured for sensing. This arrangement may be referred to as “configured grant.” As an example, one, some or all of the following resources may be configured in advance and activated for use when the UE 110 is triggered to perform sensing:
Any of the resources described in relation to step 452 of FIG. 8 that may be configured before the UE 110 enters the power-saving mode or as part of the transition of the UE 110 into the power-saving mode.
A set of time and/or frequency resources for sensing over a period T, e.g., number of slots for sensing.
A sensing repeat frequency period, e.g., which may be a multiple of T.
A transmission parameter such as a sensing waveform, and/or pilot to use.
A grant-free periodicity, e.g. how the time-frequency resources for sensing are repeated.
A sensing repeat frequency period, e.g. how many rounds of sensing are performed in the sensing window.
A signal waveform, e.g. the sensing waveform used.
A sensing feedback and/or measurement report channel.

In other embodiments, one, some, or all of the parameters listed above may instead be dynamically indicated in the downlink message transmitted in step 458 of FIG. 8 each time sensing is triggered.

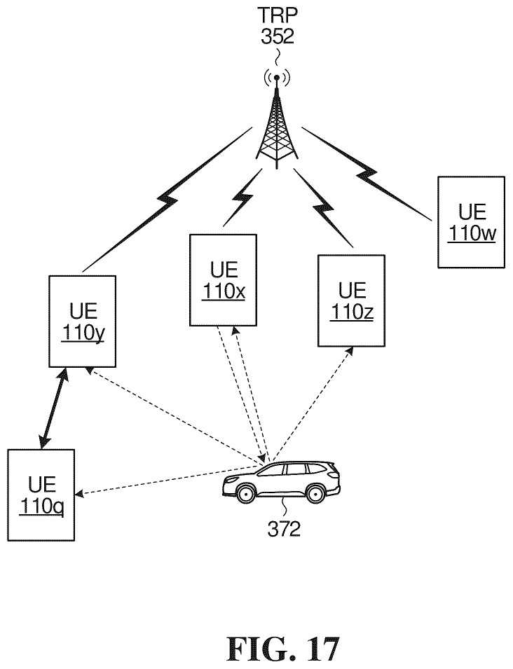

In some embodiments, the UE 110 may act as a relay for another UE that is not in the coverage of the TRP 352, but is to still participate in sensing. For example, FIG. 17 is a variation of FIG. 6 in which another UE 110q participates in sensing, but is not in the coverage of TRP 352. UE 110q cannot receive the downlink message from TRP 352 that is transmitted in step 458 of FIG. 8. UE 110q also cannot transmit directly to TRP 352 feedback obtained by the sensing performed by UE 110q. UE 110q therefore establishes sidelink communication with UE 110y who is in communication with TRP 352. UE 110y acts as a relay between UE 110q and TRP 352. For example, when UE 110y receives the downlink message in step 460 of FIG. 8, UE 110y may forward the downlink message to UE 110q over a sidelink channel, e.g. using device-to-device (D2D) communication. As another example, when UE 110y receives the downlink message, UE 110y not only looks for its indication triggering UE 110y to perform sensing, but UE 110y also looks for an indication triggering UE 110q to perform sensing. For example, UE 110y may look for both a UE sensing ID for UE 110y (which triggers UE 110y to perform sensing) and a UE sensing ID for UE 110q (which triggers UE 110q to perform sensing). The UE sensing ID for UE 110q may have been previously provided to UE 110y by UE 110q, e.g. over sidelink. In response to UE 110y finding the indication triggering UE 110q to perform sensing, UE 110y may forward the downlink message to UE 110q or instead transmit another message to UE 110q indicating that UE 110q should perform sensing. If UE 110y does not forward the downlink message directly to UE 110q, then UE 110y may transmit sensing parameters configured for UE 110q that are present in the downlink message. The UE 110y may also receive, over the sidelink from UE 110q, the feedback obtained from the sensing performed by UE 110q. The UE 110y may transmit the feedback from UE 110q to the TRP 352 on behalf of UE 110q.

Therefore, in some embodiments of the method of FIG. 8, the UE 110 may be a first UE (e.g. UE 110y), and the indication triggering first UE to perform sensing may be a first indication. The downlink message may further include a second indication used for triggering a second UE (e.g. UE 110q) to perform the sensing. In response to the presence of the second indication, first UE (e.g. UE 110y) may transmit, to the second UE (e.g. UE 110q), a message informing the second UE (e.g. UE 110q) that the second UE (e.g. UE 110q) is to perform the sensing. The method may further include receiving, from the second UE (e.g. UE 110q) feedback obtained from the sensing by the second UE, and transmitting that feedback to the TRP 352.

The relaying described above may additionally apply in relation to paging, e.g. UE 110q may share its paging ID with UE 110y, and if UE 110y finds the paging ID associated with UE 110q in the downlink message, then UE 110y may notify UE 110q by forwarding the downlink message or by a separate message. UE 110y may act as the relay for the paged data communication, e.g. UE 110y performs a network access procedure to transition into a connected state and communicates with the TRP 352 on behalf of UE 110q, acting as a relay for relaying data between TRP 352 and UE 110q.

An early notification message, such as a PEI, is described earlier that may instruct UEs to skip monitoring DCI during certain notification occasions, e.g. UEs may be instructed to skip certain paging occasions. In embodiments in which early notification messages are implemented, the UE 110y may also act as a relay between TRP 352 and UE 110q. For example, UE 110q may share its subgroup ID with UE 110y, and if the early notification message indicates that the subgroup associated with UE 110q can skip one or more paging occasions, then UE 110y may notify UE 110q, e.g. by forwarding the early notification message or sending a separate message over sidelink.

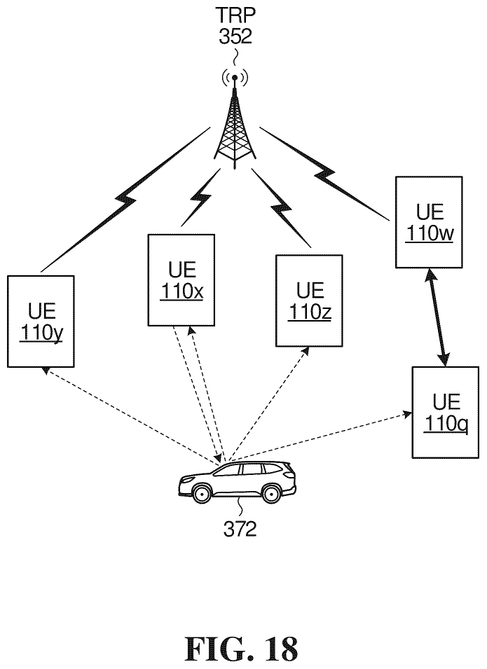

The UE performing the relaying does not necessarily have to also be performing sensing. The UE performing the relaying might not be triggered to perform sensing and/or might never perform sensing. FIG. 18 illustrates a variation of FIG. 17 in which UE 110q is still out of coverage of TRP 352, but UE 110w acts as the relay instead of UE 110y. UE 110w is not triggered to perform sensing, but UE 110q is. UE 110w finds, in the downlink message, the indication triggering UE 110q to perform sensing, and in response UE 110w either forwards the downlink message to UE 110q over sidelink or sends another message to UE 110w overside link triggering UE 110q to perform sensing. UE 110w also relays the results of the sensing back to TRP 352 on UE 110q's behalf.

In some embodiments, the downlink message transmitted in step 458 of FIG. 8 may include other information besides an indication triggering a UE 110 to perform sensing. For example, as described earlier, one or more sensing parameters may be indicated to configure the sensing performed by UE 110. In some embodiments, the downlink message transmitted in step 458 provides information that allows the UE 110 to perform directional sensing. Directional sensing may comprise the UE 110 steering one or more beams in the general direction of the target object 372 in order to transmit the sensing signal in the general direction of the target object 372 (in the situation that the UE 110 transmits a sensing signal) and/or in order to focus receiving of a sensing signal from the general direction of a target object 372. This provides a benefit because the UE 110 may be able to sense more reliably if the UE 110 has information on which general direction the sensing signal should be transmitted and/or received. Three examples of information used for directional sensing are as follows. In a first example, information is sent in the downlink message that indicates a rough location of the target object 372 expressed in terms of orientation of the target object 372 relative to a reference point known to the UEs, e.g. the reference point known to the UEs is the TRP 352 and the azimuth of departure (AoD) and zenith of departure (ZoD) from the reference point towards the target object 372 is indicated, along with an estimated distance range from the reference point. The UE 110 uses the information and its own location to determine the approximate location/orientation of the UE 110 relative to the target object 372. The UE 110 can then perform sensing using one or more beams steered in the general direction of the target object 372. In a second example, information sent in the downlink message indicates a rough location of the target object 372 expressed in terms of absolute positioning, e.g. a grid ID corresponding to a grid or volume in which the target object 372 is roughly located and/or a GPS coordinate corresponding to the rough location of the target object. In the case of grid ID, the location of the grids is known in advance by the TRP 352 and UEs. The UE 110 uses the grid ID or GPS coordinate and its own location to determine the approximate location/orientation of the UE 110 relative to the target object 372. The UE 110 can then perform sensing using one or more beams steered in the general direction of the target object 372. In a variation of these first two examples, if UE 110 is configured to receive a sensing signal, the TRP 352 may also transmit to UE 110 an indication of a location associated with a UE transmitting the sensing signal, which may also be used by UE 110 to select a beam angle for receiving the sensing signal. In a third example, the TRP 352 knows the location of the UEs transmitting and receiving the sensing signals, and also knows the rough location of the target object 372. The TRP 352 calculates, for UE 110, the direction/directional range (e.g. the beam angle) and sends an indication of the direction/directional range (e.g. beam angle) to the UE 110 in the downlink message. The UE 110 steers its beam during sensing in the direction indicated. In the first two examples, the information associated with the location of the target object 372 may be indicated in a field of the downlink message that is common to all UEs, e.g. in section 532 of enhanced paging message 504 of FIG. 15. In the third example, the TRP 352 would compute a custom beam direction for each UE, and therefore the information would instead be provided in a UE-specific field, e.g. in the enhanced paging message 504 of FIG. 15 the beam direction for UE 110x would be indicated as part of the sensing parameters for UE 110x, the beam direction for UE 110y would be indicated as part of the sensing parameters for UE 110y, etc. In all three examples, the TRP 352 is required to know the rough location of the target object 372. The rough location may be selected by the TRP 352 as the last known exact location of the target object 372 or may be based on the last known exact location of the target object 372. For example, the TRP 352 may calculate the rough location of the target object 372 based on the last known position of the target object 372, the last known direction and speed of travel of the target object 372, and the amount of time that has elapsed since the last known position/speed/direction of travel.

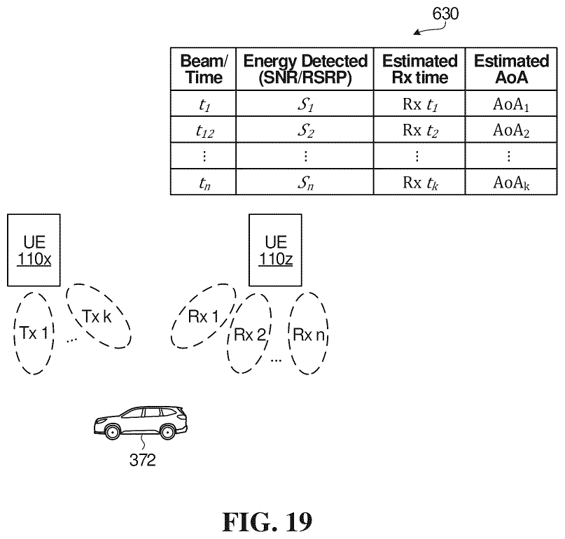

In some embodiments, when the UE 110 is triggered to perform the sensing in the method of FIG. 8, the UE 110 may be configured to perform multiple instances of sensing over a time duration/window. The time duration/window may be referred to as a sensing window, and the times at which the sensing signal is transmitted and/or received may be referred to as a sensing pattern. The sensing window and/or sensing pattern may be configured, e.g. in the message transmitted in step 452 or in the downlink message transmitted at step 458. In some embodiments, different instances of sensing are performed at different beam angles. FIG. 19 illustrates an example in which UE 110x and 110z have both been triggered to perform multiple instances of sensing. UE 110x is configured to transmit the sensing signal k consecutive times at k different beam angles, illustrated as transmit beams Tx 1, . . . , Tx k. The beam angles are close to each other and all in the general direction of the target object 372, e.g. because the directional sensing described above is implemented. UE 110z is configured to receive the sensing signal n consecutive times at n different beam angles, illustrated as receive beams Rx 1, Rx 2, . . . , Rx n. The beam angles are close to each other and all in the general direction of the target object 372, e.g. because the directional sensing described above is implemented. In the illustrated example n is larger than k (i.e. n>k) because the reflections of the sensing signals off of the target object 372 are more random and harder to predict in terms of angle(s) of reflection, and so the spread of beam angles used for receiving the sensing signals is larger. Alternatively or additionally, the amount of time spent by UE 110z performing the receive sensing might be longer than the amount of time spent by UE 110x transmitting the sensing signals. In the illustrated example, UE 110z determines the information illustrated in table 630 at each instance of sensing, i.e. for each of receive beams Rx 1 to Rx n. At time t₁, the UE 110z performs receive sensing at beam angle Rx 1, which involves attempting to detect a sensing signal reflected off of target object 372. UE 110z attempts to detect energy s₁, which may be in the form of signal-to-noise ratio (SNR) and/or reference signal receive power (RSRP). UE 110z also determines the time at which the sensing signal is received (Rx t₁) and the angle of arrival (AoA₁₎. The time at which the sensing signal is received (Rx t₁) compared to the time t₁ may be used to determine the propagation time of the reflected path.

The same action is repeated for each of receive sensing beam angles Rx 2 to Rx n. Then, in some embodiments, when the UE 110z is to transmit feedback obtained from the sensing, the UE 110z selects the row of table 630 that has the most reliable/robust results based on certain selection criteria, e.g. the row in which the sensing signal has the highest detected energy. Only information in that row (or information based on the values in that row) is fed back to the TRP 352, e.g. in the message transmitted in step 468 of FIG. 8. In some embodiments, information in or based on multiple rows in table 630 may be fed back to the TRP 352 if those multiple rows all had reliable values (e.g. all had a sensing signal with a detected energy above a certain threshold). In some embodiments, if none of the rows in table 630 have reliable values, the UE 110z may transmit a NACK to the TRP 352 instead of information from table 630.

The benefit of the method described in relation to FIG. 19 is that the sensing may possibly be performed more reliably because multiple sensing signals are being transmitted and/or received at different times at different beam angles, with the strongest one(s) received being used for the feedback. The specific sensing signal transmission and/or receive time patterns and beam sweeping directions may be configured by the network via the message transmitted in step 452 of FIG. 8 (e.g. in RRC signaling before the UE enters the power-saving mode) or via the downlink message sent in step 458 of FIG. 8.

In some embodiments, sensing may need to be performed by one or more UEs not in a power-saving mode, e.g. the one or more UEs might be in a connected mode, such as an RRC Connected state. In some embodiments, a UE not in a power-saving mode (e.g. a UE in an RRC Connected state) may be configured to monitor occasions (such as paging occasions) for DCI scheduling a downlink message triggering that UE to perform sensing. For example, the UE might not monitor for being paged (because the UE is already connected to the network with an established communication session), but the UE might still monitor for being triggered to perform sensing. In other embodiments, UEs not in a power-saving mode may be triggered to perform sensing in broadcast, groupcast, or UE-specific signaling. The signaling might also configure one or more parameters related to sensing. The signaling may be sent in DCI. The following is a non-exhaustive list of one or more items that may be transmitted in the signaling:
Sensing beam and/or timing patterns. For example, the signaling may include a field of M bits providing an indication of sensing signals to be transmitted and/or received in different transmit time intervals (TTIs). A transmission pattern in duration may be defined.
Sensing period and/or number of repeated patterns. For example, the signaling may include a field of N bits indicating such information, which be used by a UE receiving the sensing signal to better detect or measure the sensing signals.
Transmit and/or receive sensing IDs. For example, an ID can be used to indicate which UEs are to transmit a sensing signal. The ID may be UE-specific or associated with a group of UEs, e.g. to indicate that all UEs in the group are to transmit the sensing signal. Additionally or alternatively, an ID can be used to indicate which UEs are to receive a sensing signal. The ID may be UE-specific or associated with a group of UEs, e.g. to indicate that all UEs in the group are to receive the sensing signal. In some embodiments, the UEs may be in one or more sensing groups or subgroups. One example is as follows. The UEs are all part of a sensing group and the signaling is in DCI scrambled by a sensing RNTI specific to the sensing group. The UEs in the sensing group are separated into subgroups. The signaling includes a field (e.g. a bitmap) indicating what subgroups are to transmit a sensing signal and/or what subgroups are to receive a sensing signal.
A resource pool index. For example, the signaling may include a field of log₂/bits indicating one of/resource pools of sensing signals to be used by a UE transmitting a sensing signal.
A time gap before performing the sensing, e.g. a field of n bits indicating the number of slots from when the signaling is received to when the sensing is to begin.
The time and/or frequency resources used for performing the sensing.
The repeat frequency period, e.g. the repeating rate of the sensing in terms of units of TTIs or slots.
An indication of time and/or frequency resources for transmitting feedback obtained from the sensing, e.g. a PUCCH resource indicator if the feedback is transmitted on a PUCCH.
A redundancy version (RV) and/or HARQ process ID associated with retransmissions.

The signaling may indicate one or more of the items listed above. In some embodiments, the signaling is DCI and a sensing RNTI (or other predefined RNTI) may be configured (e.g. by RRC signaling) for scrambling the DCI. The sensing RNTI (or other predefined RNTI) may be shared by a group of UEs receiving the signaling.

For a UE in a power-saving mode, as described earlier the UE may monitor during occasions (e.g. paging occasions) for DCI scheduling a downlink message. Examples are explained earlier with reference to FIGS. 10 to 16. In some embodiments, the occasions for monitoring for the DCI scheduling the downlink message, e.g. the paging occasions, may be configured by information associated with a synchronization signal block (SSB) and system information (SI). For example, system information, such as a master information block (MIB) or a system information block (SIB) may configure one or more monitoring occasions and/or one or more parameters related to sensing. This may occur as part of the configuration described in steps 452/454 of FIG. 8. In some embodiments, the configuration may occur as part of an initial access procedure. In some embodiments, when the UE 110 first connects with the network, e.g. during initial access, the UE 110 transmits a capability report to the TRP 352 indicating the sensing capability of the UE 110. For example, if UE 110 can only receive sensing signals and not transmit sensing signals, then the UE 110 indicates this to the TRP 352 so that the network can configure sensing appropriately (e.g. not expect UE 110 to transmit a sensing signal). In some embodiments, the UE 110 may provide to TRP 352 an ID associated with sensing, e.g. the UE 110x may provide UE Sensing ID 1 to TRP 352 so that the TRP 352 knows which ID to use when triggering UE 110x to perform sensing in enhanced paging message 504 of FIG. 15.

In embodiments in which step 462 and/or step 468 of FIG. 8 is/are performed, then there are different options for transmitting the uplink messages. In one example, if step 462 is performed (i.e. the UE 110 transmits an ACK indicating that it will perform sensing), then an acknowledgment channel may be configured to be used to transmit the ACK. In another example, if step 468 is performed (i.e. the UE 110 transmits feedback from the sensing), then a sensing reporting channel may be configured to transmit the feedback. The configured channels may be in uplink control channels, e.g. time-frequency resources in a PUCCH. The channels may be configured in the message transmitted in step 452 of FIG. 8.

In some embodiments, if step 462 and/or step 468 are performed, they may be performed as part of a RACH procedure, e.g. as part of a 2-step RACH procedure. An example is a as follows. Besides sensing, the UE 110 performs a RACH procedure, e.g. for initial network access and connection establishment. The RACH procedure includes one or more uplink messages transmitted by the UE 110. The UE 110 includes the ACK of step 462 and/or the feedback of step 468 in an uplink message transmitted by the UE 110 during the RACH procedure. For example, if 2-step RACH is being performed, the ACK of step 462 and/or the feedback of step 468 may be sent in message A (“Msg A”) transmitted by the UE 110 as part of the 2-step RACH. As another example, the ACK of step 462 and/or the feedback of step 468 may be sent in a Message 1 (“Msg 1”) or Message 3 (“Msg 3”) transmitted by the UE 110 as part of a RACH procedure. Therefore, in some embodiments the method of FIG. 8 may include transmitting the ACK in step 462 and/or transmitting the feedback in step 468 as part of an uplink message transmitted in a RACH procedure (e.g. in a RACH channel). For example, the ACK and/or feedback may be appended to or incorporated into the uplink message transmitted in the RACH procedure. If the ACK (or NACK) is sent in step 462, it may be sent along with a UE sensing ID (or UE I-RNTI) configured by the network, e.g., configured at step 452 or during the UE transition from a connected state (e.g. RRC Connected state) to a power-saving mode/state.

In some embodiments, when the UE 110 is triggered to perform sensing, the UE first transitions from a power-saving mode to a connected state (e.g. an RRC Connected state) to perform the sensing. A RACH procedure may be performed as part of the transition from the power-saving mode to the connected state. In other embodiments, when the UE 110 is triggered to perform sensing, a RACH procedure may be performed for transmission timing synchronization, but the UE 110 does not transition out of the power-saving mode. In some embodiments, the UE 110 may optionally receive from the network an instruction or message to stay in the power-saving mode for the sensing operation. The UE may transmit the ACK or NACK (as described above at step 462) in the RACH procedure. The UE may receive a timing advance (TA) adjustment in the RACH procedure. However, the UE does not transition out of the power-saving mode, e.g. the UE does not transition to a connected state. In other embodiments, instead of or in addition to performing a RACH procedure to obtain transmission timing synchronization for the sensing, the timing synchronization may be provided using SI/SSB and/or a downlink common reference signal.

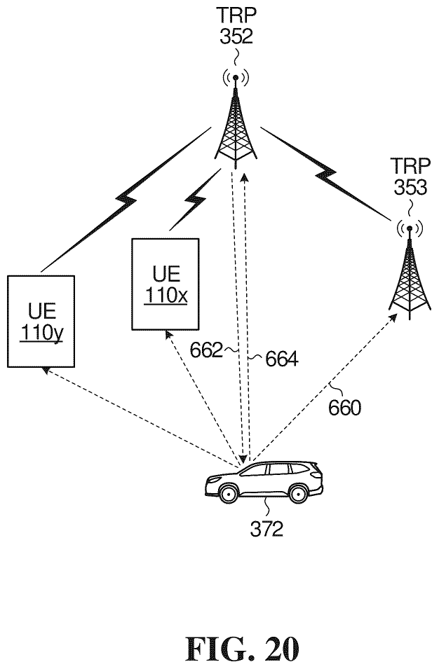

In the method of FIG. 8, it is a UE (UE 110) that is triggered to perform sensing by a message from TRP 352. However, this does not necessarily need to be the case, e.g. a TRP or integrated access and backhaul (IAB) device may be triggered to perform sensing. Therefore, FIG. 8 and all additions and variations thereof described herein may be modified such that an apparatus may be triggered to perform sensing. The apparatus might be a UE (e.g. UE 110), but the apparatus could instead be something else, such as a TRP. FIG. 20 illustrates a variation of FIG. 6 in which a TRP 353 is triggered to perform sensing. In the illustrated example, TRP 353 is configured to receive the sensing signal, as shown at 660. In some embodiments, unlike UE 110x and UE 110y, the TRP 353 might not be triggered via the downlink message transmitted in step 458 of FIG. 8. For example, the TRP 353 may be triggered to perform sensing via a backhaul or TRP-to-TRP link. The TRP 353 may also use this link to feedback the results of the sensing. In the example in FIG. 20, TRP 352 also participates in the sensing by transmitting and receiving the sensing signal, as shown at 662 and 664. The TRP 353 or the TRP 352 or another TRP (not illustrated) may be the serving TRP.

Also, in FIG. 8, it is a TRP (TRP 352) that transmits the downlink message triggering the sensing. However, this is does not necessarily need to be the case, e.g. a UE (such as a “master UE” or relaying UE) could transmit the downlink message. Therefore, FIG. 8 and all additions and variations thereof described herein may be modified such that a device may transmit the downlink message. The device may be a TRP (e.g. TRP 352), but the device could instead be something else, e.g. a UE.

In view of the foregoing, the method of FIG. 8 and all additions and variations thereof described herein may be performed by a device and apparatus. The device may perform step 458 and (if included) steps 452, 464, and/or 470. The device may perform any of the variations or examples described herein as being performed by the TRP 352. The device may be a network device, such as a TRP, e.g. TRP 352 described in relation to FIG. 5. The device may include at least one processor and a memory storing processor-executable instructions that, when executed by the at least one processor, cause the device to perform method steps in FIG. 8. The device may be a component of a network device, e.g. an integrated circuit chip that controls the device to perform method steps in FIG. 8. The apparatus may perform steps 460 and 466 and (if included) steps 454, 456, 462, and/or 468. The apparatus may perform any of the variations or examples described herein as being performed by a UE, such as by UE 110. The apparatus may be an ED or UE, e.g. UE 110 described in relation to FIG. 5. The apparatus may include at least one processor and a memory storing processor-executable instructions that, when executed by the at least one processor, cause the apparatus to perform method steps of FIG. 8. The apparatus may be a component of a piece of equipment such as a component of a UE. For example, the apparatus may be an integrated circuit chip that controls the UE to perform method steps in FIG. 8.

Many variations of FIG. 8 are described herein, including examples of specific messages, steps, etc. Permutations of all of these variations and examples are contemplated. For example, any of the methods for transmitting the downlink message 504 described with reference to FIGS. 10 to 14 may be combined with any of the variations of downlink messages described herein (e.g. in relation to FIGS. 9 and 15), which may be combined with any of the sensing parameter configurations described herein (in relation to the message sent in step 452 or in the downlink message sent in step 458), etc.

Note that the expression “at least one of A or B,” as used herein, is interchangeable with the expression “A and/or B.” It refers to a list in which you may select A or B or both A and B. Similarly, “at least one of A, B, or C,” as used herein, is interchangeable with “A and/or B and/or C” or “A, B, and/or C.” It refers to a list in which you may select: A or B or C, or both A and B, or both A and C, or both B and C, or all of A, B and C. The same principle applies for longer lists having a same format.

Although the present invention has been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although the present invention and its advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

1. A method performed by an apparatus in a power-saving mode, the method comprising:
receiving, by the apparatus in the power-saving mode, an indication in a downlink message, the indication used for triggering the apparatus to perform sensing;
in response to the receiving the indication, performing, by the apparatus in the power-saving mode, at least one of: transmitting or receiving a sensing signal.

2. The method of claim 1, wherein the downlink message is associated with paging.

3. The method of claim 2, wherein the downlink message comprises a paging message supplemented with the indication.

4. The method of claim 1, wherein the indication comprises an identifier (ID) associated with the apparatus in the downlink message.

5. The method of claim 4, wherein the ID is configured to be associated with the apparatus before the apparatus enters the power-saving mode or as part of transition of the apparatus into the power-saving mode.

6. The method of claim 5, wherein at least one of following is also configured before the apparatus enters the power-saving mode or as the part of the transition of the apparatus into the power-saving mode:
a time-frequency resource for performing the sensing;
whether the apparatus is to transmit or receive the sensing signal or both transmit and receive the sensing signal;
an offset timing for starting the sensing;
a sensing window;
a sensing repeat pattern;
a sensing waveform;
a time-frequency resource for transmitting feedback obtained from the sensing; or
whether the apparatus is to send an acknowledgement confirming that the apparatus will perform the sensing.

7. The method of claim 1, wherein the downlink message further indicates at least one of:
a time-frequency resource for performing the sensing;
whether the apparatus is to transmit or receive the sensing signal or both transmit and receive the sensing signal;
an offset timing for starting the sensing;
a sensing window;
a sensing repeat pattern;
a sensing waveform;
a time-frequency resource for transmitting feedback obtained from the sensing;
whether the apparatus is to send an acknowledgement confirming that the apparatus will perform the sensing;
a location associated with a target object to be sensed;
a beam direction for transmitting the sensing signal; or
a beam direction for receiving the sensing signal.

8. The method of claim 7, wherein the downlink message indicates the location associated with the target object, and the location is provided in a field that is common to all apparatuses triggered to perform the sensing.

9. The method of claim 1, wherein the downlink message is associated with a paging occasion, and the method further comprises:
decoding control information prior to the paging occasion;
obtaining, from the control information, an indication of whether or not the apparatus will be triggered to perform the sensing during the paging occasion; and
receiving the downlink message only in response to the control information indicating that the apparatus will be triggered to perform the sensing during the paging occasion.

10. The method of claim 1, wherein the downlink message further includes a second indication used for triggering a second apparatus to perform the sensing, and wherein the method further comprises:
in response to presence of the second indication, transmitting, by the apparatus to the second apparatus, a message informing the second apparatus that the second apparatus is to perform the sensing.

11. A method performed by a device, the method comprising:
transmitting an indication in a downlink message, the indication used for triggering an apparatus in a power-saving mode to perform sensing;
after the transmitting, receiving, from the apparatus in the power-saving mode, feedback obtained by the apparatus from the sensing.

12. The method of claim 11, wherein the downlink message is associated with paging.

13. The method of claim 12, wherein the downlink message comprises a paging message supplemented with the indication used for triggering the apparatus to perform the sensing.

14. The method of claim 11, wherein the indication comprises an identifier (ID) associated with the apparatus in the downlink message.

15. The method of claim 14, wherein the ID is configured by the device to be associated with the apparatus before the apparatus enters the power-saving mode or as part of transition of the apparatus into the power-saving mode.

16. The method of claim 15, wherein at least one of following is also configured by the device before the apparatus enters the power-saving mode or as the part of the transition of the apparatus into the power-saving mode:
a time-frequency resource for performing the sensing;
whether the apparatus is to transmit or receive a sensing signal or both transmit and receive the sensing signal;
an offset timing for starting the sensing;
a sensing window;
a sensing repeat pattern;
a sensing waveform;
a time-frequency resource for transmitting feedback obtained from the sensing; or
whether the apparatus is to send an acknowledgement confirming that the apparatus will perform the sensing.

17. The method of claim 11, wherein the downlink message further indicates at least one of:
a time-frequency resource for performing the sensing;
whether the apparatus is to transmit or receive a sensing signal or both transmit and receive the sensing signal;
an offset timing for starting the sensing;
a sensing window;
a sensing repeat pattern; a sensing waveform;
a time-frequency resource for transmitting feedback obtained from the sensing;
whether the apparatus is to send an acknowledgement confirming that the apparatus will perform the sensing;
a location associated with a target object to be sensed;
a beam direction for transmitting the sensing signal; or
a beam direction for receiving the sensing signal.

18. The method of claim 17, wherein the downlink message indicates the location associated with the target object, and the location is provided in a field that is common to all apparatuses triggered to perform the sensing.

19. The method of claim 11, wherein the downlink message includes multiple IDs to trigger multiple apparatuses to perform the sensing, the multiple IDs each associated with a respective different apparatus of one or more of the apparatuses, and the multiple IDs including an ID associated with at least the apparatus that triggers the apparatus to perform the sensing.

20. The method of claim 11, wherein the downlink message is associated with a paging occasion, and the method further comprises:
transmitting control information prior to the paging occasion, the control information indicating whether or not the apparatus will be triggered to perform the sensing during the paging occasion.
